(19) United States
(12) Patent Application Publication
(10) Pub. No.: US 2026/0292290 A1
(43) Pub. Date: Sep. 24, 2026

(54) Content-Aware Multi-Channel Multi-Device Time Alignment

(71) Applicant: Sonos, Inc., Barbara, CA (US)

(72) Inventors: Peter Dodds, Santa Barbara, CA (US); Roberto Dizon, Santa Barbara, CA (US)

(21) Appl. No.: 19/470,042

(22) PCT Filed: Mar. 27, 2024
(86) PCT No.: PCT/US2024/021671

§ 371 Date: Sep. 27, 2025

Related U.S. Application Data
(60) Provisional application No. 63/492,531, filed on Mar. 28, 2023.

(51) Int. Cl. H04N 21/43; H04S 7/00

(52) U.S. Cl. CPC H04N 21/43076; H04S 7/302

(57) ABSTRACT

Disclosed embodiments include a first playback device determining whether received multichannel audio content has corresponding video content and (i) when the multichannel audio content has corresponding video content, causing a second playback device to play the multichannel audio content according to a first delay scheme to achieve lip synchrony with playback of video corresponding to the multichannel audio content, and (ii) when the multichannel audio content does not have corresponding video content, causing the second playback device to play the multichannel audio content according to a second delay scheme that is configured to cause the multichannel audio content played by the second playback device and a different playback device to arrive at a listening position at substantially the same time.

### CROSS-REFERENCE TO RELATED APPLICATIONS

The present application claims priority U.S. Provisional App. 63/492,531, titled “Content-Aware Multi-Channel Multi-Device Time Alignment” (22-1009P), filed Mar. 28, 2022, and currently pending. The entire contents of App. 63/492,531 are incorporated herein by reference.

### FIELD OF THE DISCLOSURE

The present disclosure is related to consumer goods and, more particularly, to methods, systems, products, features, services, and other elements directed to media playback systems, media playback devices, and aspects thereof.

### BACKGROUND

Options for accessing and listening to digital audio in an out-loud setting were limited until in 2002, when SONOS, Inc. began development of a new type of playback system. Sonos then filed one of its first patent applications in 2003, titled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), individuals can play most any music they like in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A shows a partial cutaway view of an environment having a media playback system configured in accordance with aspects of the disclosed technology.

FIG. 1B shows a schematic diagram of the media playback system of FIG. 1A and one or more networks.

FIG. 1C shows a block diagram of a playback device.

FIG. 1D shows a block diagram of a playback device.

FIG. 1E shows a block diagram of a network microphone device.

FIG. 1F shows a block diagram of a network microphone device.

FIG. 1G shows a block diagram of a playback device.

FIG. 1H shows a partially schematic diagram of a control device.

FIG. 1-I through 1L show schematic diagrams of corresponding media playback system zones.

FIG. 1M shows a schematic diagram of media playback system areas.

FIG. 2A shows a front isometric view of a playback device configured in accordance with aspects of the disclosed technology.

FIG. 2B shows a front isometric view of the playback device of FIG. 3A without a grille.

FIG. 2C shows an exploded view of the playback device of FIG. 2A.

FIG. 3A shows a front view of a network microphone device configured in accordance with aspects of the disclosed technology.

FIG. 3B shows a side isometric view of the network microphone device of FIG. 3A.

FIG. 3C shows an exploded view of the network microphone device of FIGS. 3A and 3B.

FIG. 3D shows an enlarged view of a portion of FIG. 3B.

FIG. 3E shows a block diagram of the network microphone device of FIGS. 3A-3D

FIG. 3F shows a schematic diagram of an example voice input.

FIGS. 4A-4D show schematic diagrams of a control device in various stages of operation in accordance with aspects of the disclosed technology.

FIG. 5 shows front view of a control device.

FIG. 6 shows a message flow diagram of a media playback system.

FIG. 7 shows an example configuration of a media playback system configured to perform aspects of content-aware multi-channel, multi-device time alignment according to some embodiments.

FIG. 8 shows an example method flowchart implemented by a playback device configured to perform aspects of content-aware multi-channel, multi-device time alignment according to some embodiments.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

The various types of playback devices disclosed and described herein can be implemented in several different configurations to play many different types of audio content from many different media sources, including but not necessarily limited to, audio content that has corresponding video content and audio content without corresponding video content.

For example, some playback devices can be configured in a home theater implementation with one or more other playback devices. One type of home theater implementation includes a home theater primary and one or more home theater satellites configured into a home theater zone (sometimes referred to as a bonded zone or home theater bonded zone), where the home theater primary, among other features, (i) receives audio content from an audio source, (ii) processes the received audio content, including generating playback timing for the audio content that will be used by the home theater primary and the home theater satellites to play audio based on the audio content, (iii) distributes the audio content and the playback timing for the audio content to the home theater satellites, and (iv) coordinates groupwise playback of audio (based on the audio content and playback timing) via the home theater satellite(s) and, in many instances, the home theater primary.

In some illustrative example configurations using commercially available playback devices from Sonos, Inc., a home theater bonded zone includes (i) a home theater primary, (e.g., a Sonos Amp, or a soundbar such as a Sonos Arc, Sonos Beam, or Sonos Ray) and (ii) one or more home theater satellites, e.g., one or more Sonos Subs or Sonos Sub Minis configured to play low frequency bass signals and/or one or more Sonos Era 300s, Sonos Era 100s, Sonos Play Ones, Sonos Play Ones, Sonos Moves, Sonos Roams, or other playback devices configured to play rear and/or other surround sound channels of audio.

Aspects of the disclosed embodiments include groupwise playback of multichannel audio content, including (i) playing one or more channels of multichannel audio content according to one of several different delay schemes and/or (ii) causing one or more channels of multichannel audio content to be played according to one of several different delay schemes. The delay schemes include a lip synchrony delay scheme, a standard delay scheme, and a sound steering delay scheme.

In the lip synchrony delay scheme, one or more (or all) of the playback devices in the playback group play audio content (i) in synchrony with one or more (or all) of the playback devices in the playback group and/or (ii) in lip synchrony with a video display playing video content corresponding to the audio content. Playback of the audio content in synchrony with each other and in lip synchrony with the corresponding video content is accomplished via playing the audio according to playback timing generated with a timing advance of less than about 10 to 20 milliseconds relative to a reference clock that is used for (i) generating playback timing and (ii) playing audio content as described herein.

The short timing advance used for the lip synchrony delay scheme causes playback devices to play the audio content very shortly after receipt thereof, which helps to maintain lip synchrony with the video display playing the corresponding video content. However, the short timing advance does not allow much time for (i) the audio sourcing device (e.g., a home theater primary) to generate the audio content and transmit the audio content and playback timing to each of the playback devices in the playback group (e.g., home theater satellites) or (ii) the playback devices in the playback group to receive, process, and play the audio content. As a result, in some instances, a playback group playing audio content according to the lip synchrony delay scheme may experience temporary dropouts of audio playback, but often no more than about 20 to 50 milliseconds during periods of network congestion.

In the standard delay scheme, all of the playback devices in the playback group play audio content in synchrony with each other. Playback of the audio content in synchrony with each other is accomplished via playing the audio content according to playback timing that was generated with a timing advance that may be as low as about 20 milliseconds or up to several hundred milliseconds or even a few seconds relative to the reference clock that is used for (i) generating playback timing and (ii) playing audio content as described herein.

Compared to the short timing advance utilized in the lip synchrony delay scheme, the longer timing advance utilized in the standard delay scheme allows more time for (i) the audio sourcing device (e.g., a home theater primary) to generate playback timing and transmit the audio content and playback timing to each of the playback devices in the playback group (e.g., home theater satellites) and (ii) the playback devices in the playback group to receive, process, and play the audio content. As a result, a playback group playing audio content according to the standard delay scheme is not necessarily expected to experience temporary dropouts of audio playback even during periods of network congestion because the longer timing advance utilized in the standard delay scheme allows the playback devices to build up larger buffers of audio content (compared to the lip synchrony scheme). These larger buffers of audio content enable the playback devices to continue playing audio content without dropouts even when packets of audio content may be temporarily delayed because of network congestion or other reasons.

Although the longer timing advances utilized in the standard delay scheme are typically not suitable for playing the audio content in lip synchrony with the audio content's corresponding video content, lip synchrony is not typically applicable for audio content that does not have any corresponding video content. For example, if the audio content is just music, and there is no corresponding video content to play the music in lip synchrony with, then the shorter timing advance used in the lip synchrony delay scheme may not be necessary or desirable, particularly if using the shorter timing advance might make temporary dropouts more likely. In some examples, corresponding visual content may be generated or displayed that corresponds with currently playing audio content. In these scenarios, however, the time requirements may be less stringent than those associated with lip synchrony. For instance, playback of audio content may include a corresponding visual output of lyrics on a video display. Individual lines of lyrics may correspond, for example, to several seconds of audio rather than the less than 50 millisecond time frames associated with lip synchrony. Thus, in such circumstances, the playback group may play audio that has corresponding video content according to the standard delay scheme rather than the lip synchrony delay scheme.

In the sound steering delay scheme, the playback devices in the playback group play audio content in synchrony with each other, but each of the playback devices plays the audio content with slightly different playback timing so as to “steer” the arrival of sound played by the playback group to a particular listening position within a listen area. Instead of each playback device in the playback group playing the audio according to the same playback timing as with the above-described lip synchrony delay scheme and the standard delay scheme, when the audio sourcing device (e.g., a home theater primary) implements the sound steering delay scheme, the audio sourcing device generates slightly different playback timing for each of the playback devices in the playback group (e.g., the home theater satellites). The differences in each playback device's playback timing are designed to cause audio played by different playback devices to arrive at a listening position at substantially the same time.

The sound steering delay scheme is accomplished by using different timing advances when generating playback timing for each playback device. For example, if the listening position is closer to the left side of a listening area than the right side of the listening area, then when the audio sourcing device is generating playback timing for the audio content, the audio sourcing device uses a slightly longer timing advance(s) for the playback timing for the playback device(s) on the left side of the listening as compared to the timing advance(s) for the playback timing for the playback device(s) on the right side of the listening area. By using a slightly longer timing advance for the playback devices on the left side of the listening area (or using a slightly shorter timing advance for the playback devices on the right side of the listening area), the playback devices on the right side of the listening area will play corresponding frames of audio content slightly sooner than when the playback devices on the left side play those same frames of audio content (or frames corresponding to those same frames of audio content). As a result, the audio corresponding to that frame of audio content will arrive at the listening position at substantially the same time. For stereo audio content, the sound steering delay scheme can enhance the stereo effect experienced a listener at the listening position. Similarly, for surround sound or other multichannel content, the sound steering delay scheme can enhance the surround sound effect experienced by a listener at the listening position.

In connection with playing one or more channels of multichannel audio content according to one of the several different delay schemes and/or causing one or more channels of multichannel audio content to be played according to one of several different delay schemes, some embodiments include a first playback device (i) determining whether multichannel audio content received via a network interface has corresponding video content, (ii) when the multichannel audio content has been determined to have corresponding video content, causing a second playback device to play at least a portion of the multichannel audio content according to a first delay scheme, where the first delay scheme is configured to cause the second playback device to play at least a portion of the multichannel audio content in lip synchrony with playback of video corresponding to the multichannel audio content, and (iii) when the multichannel audio content has been determined to not have corresponding video content, causing the second playback device to play at least a portion of the multichannel audio content according to a second delay scheme that is different than the first delay scheme. In some embodiments, the second delay scheme is configured to cause the at least a portion of the multichannel audio content played by the second playback device and a corresponding portion of the multichannel audio content played by a different playback device to arrive at a listening position at substantially the same time.

Some embodiments additionally or alternatively include using a software-implemented analysis of the multichannel audio content performed by a machine learning classifier to classify the multichannel audio content as one of at least (i) multichannel audio content that has corresponding video content that includes voice dialog, (ii) multichannel audio content that has corresponding video content that does not include voice dialog, or (iii) multichannel audio content that does not have corresponding video content. Then, for a first portion of the multichannel audio content that has been determined to have corresponding video content that includes voice dialog, the first playback device and the second playback device play the first portion of the multichannel audio content according to the first delay scheme, such as the lip synchrony scheme. And for a second portion of the multichannel audio content that has been determined to have corresponding video content that does not include voice dialog, the first playback device and the second playback device play the second portion of the multichannel audio content according to a second delay scheme, such as the standard scheme or the sound steering scheme.

Some embodiments additionally include determining whether playback of the multichannel audio content is to be switched from being played back via a group of playback devices to being played back via headphones. And when the playback is to be switched to the headphones, the out-loud playback devices in the playback group may cease playing the multichannel audio content, and headphones begin to play back the multichannel audio. In some instances, the headphones are configured to play the audio content according to the lip synchrony scheme regardless of whether the multichannel audio content received via the one or more network interfaces has corresponding video content.

These and other features described herein improve upon earlier-developed systems and methods including, for example the systems and methods disclosed and described in the following earlier-filed patent applications assigned to Sonos, Inc.

U.S. application Ser. No. 13/274,059, titled “Systems, Methods, Apparatus, and Articles of Manufacture to Control Audio Playback,” filed on Oct. 14, 2011, and issued on Mar. 3, 2015, as U.S. Pat. No. 8,971,546 (“Millington '546”), describes, among other features, example configurations where, when and audio playback device changes from one audio information source (e.g., an Internet music source) to a local audio information source, the audio playback device determines whether a scene is triggered by the change in the signal source. Millington '546 describes a scene as including a grouping of audio playback devices that are configured to perform one or more actions when an event is detected. In one example, the audio playback device, a subwoofer, and rear surround sound speakers automatically configure themselves for groupwise playback when the signal source changes.

U.S. application Ser. No. 14/684,208, titled “Identification of Audio Content Facilitated by Playback Device,” filed on Apr. 10, 2015, and issued on Jun. 13, 2017, as U.S. Pat. No. 9,678,707 (“Clayton '707), describes, among other features, a playback device (i) receiving digital data representing audio content, (ii) sending at least a portion of the digital data to an identification system configured to identify the audio content based on the at least a portion of the digital data, (iii) receiving information associated with the audio content from the identification system, and (iv) in response to receiving the information associated with the audio content from the identification system, sending the received information to a control device that is configured to control the playback device.

U.S. application Ser. No. 17/808,169, titled “Systems and Methods for Coordinating Playback of Analog and Digital Media Content,” filed on Jun. 22, 2022, and currently pending (“Wilberding '783”) discloses, among other features, identifying content being played back via an analog device (e.g., a record player) and finding corresponding streaming content.

U.S. application Ser. No. 18/068,494, titled “Speech Enhancement Based on Metadata Associated with Audio Content,” filed on Dec. 19, 2022, and currently pending (“Millington '494”) discloses, among other features, detecting a content type (e.g., media content that includes voice dialog) and adjusting an audio parameter (e.g., activating a speech enhancement mode) accordingly.

U.S. application Ser. No. 13/013,740, titled “Controlling and Grouping in a Multi-Zone Media System,” filed on Jan. 25, 2011, and issued on Dec. 1, 2015, as U.S. Pat. No. 9,202,509 (“Kallai '509”) discloses, among other features, techniques for grouping individual audio playback devices for multichannel listening. Some embodiments in Kallai '509 include measuring time delays related to transmission latency between playback devices and synchronizing playback of audio content by the playback devices based on the measured delays.

U.S. application Ser. No. 13/083,499, titled “Multi-Channel Pairing in a Media System,” filed on Apr. 8, 2011, and issued on Jul. 22, 2014, as U.S. Pat. No. 8,788,080 (“Kallai '080”) describes, among other features, configured playback devices for home theater bonded zone configurations. Some embodiments in Kallai '080 include detecting whether a user is watching television or playing music, and changing one or more equalization parameters of audio playback based on whether the user is watching television or playing music. In some examples, changing the equalization parameters includes changing a time-delay adjustment associated with audio playback.

U.S. application Ser. No. 13/632,731, titled “Providing a Multi-Channel and a Multi-Zone Audio Environment,” filed on Oct. 1, 2012, and issued on Dec. 6, 2016, as U.S. Pat. No. 9,516,440 (“Jarvis '440”), discloses, among other features, applying different delays to playback devices based on, for example, whether the playback devices are part of a home theater bonded zone or group with the home theater bonded zone. Some embodiments in Jarvis '440 include processing and 2-channel audio content differently than 1-channel audio or audio with more than 2 channels.

Some embodiments of Jarvis '440 further include playing audio associated with video differently than audio that is not associated with video.

U.S. application Ser. No. 15/009,319, titled “Systems and Methods of Distributing Audio to One or More Playback Devices,” filed on Jan. 28, 2016, and issued on Feb. 6, 2018, as U.S. Pat. No. 9,886,234 (“Lin '234”) describes, among other features, using a computing device that does not play audio content to process audio content and send the processed audio content to playback devices for playback.

U.S. application Ser. No. 15/211,822, titled “Spatial Audio Correction,” filed on Jul. 15, 2016, and issued on Oct. 17, 2017, as U.S. Pat. No. 9,794,710 (“Sheen '710”) describes, among other features, configuring playback devices with one playback configuration when playing music and a different playback configuration when playing audio that is paired with video (e.g., television content). Some embodiments of Sheen '710 include determining delays for different sound axes, and using the determined delays to align time-of-arrival of sounds from each sound axis at a particular location.

U.S. application Ser. No. 16/415,783, titled “Wireless Multi-Channel Headphone Systems and Methods,” filed on May 17, 2019, and issued on Nov. 16, 2021, as U.S. Pat. No. 11,178,504 (“Beckhardt '504”) discloses, among other features, a surround sound controller and one or more wireless headphones that switch between operating in various modes. In a first mode, the surround sound controller uses a first Modulation and Coding Scheme (MCS) to transmit first surround sound audio information to a first pair of headphones. In a second mode, the surround sound controller uses a second MCS to transmit (a) the first surround sound audio information to the first pair of headphones and (b) second surround sound audio information to a second pair of headphones. In operation, the first MCS corresponds to a lower data rate at a higher wireless link margin than the second MCS.

U.S. application Ser. No. 16/415,796, titled “Wireless Transmission to Satellites for Multichannel Audio System,” filed on May 17, 2019, and issued on Jun. 9, 2020, as U.S. Pat. No. 10,681,463 (“Beckhardt '463”) discloses, among other features, schemes for transmitting data wirelessly to home theater satellites based on corresponding acoustic delays and knowledge of wireless propagation delays.

U.S. application Ser. No. 17/247,029 titled “Systems and Methods of Spatial Audio Playback with Enhanced Immersiveness,” filed on Nov. 24, 2020 and issued on Dec. 28, 2021, as U.S. Pat. No. 11,212,635 (“MacLean '635”) discloses, among other features, adjusting relative delays between up-firing and side-firing transducers on a single playback device based on listener location.

However, none of the aforementioned earlier-filed applications, individually or in combination, disclose the particular combinations of features and functions shown and described herein that relate to (i) determining whether multichannel audio content received via a network interface has corresponding video content, (ii) when the multichannel audio content has corresponding video content, causing a second playback device to play at least a portion of the multichannel audio content according to a first delay scheme that is configured to cause the second playback device to play at least a portion of the multichannel audio content in lip synchrony with playback of video corresponding to the multichannel audio content, and (iii) when the multichannel audio content does not have corresponding video content, causing the second playback device to play at least a portion of the multichannel audio content according to a second delay scheme that is different than the first delay scheme.

The entire contents of U.S. application Ser. Nos. 13/274,059; 14/684,208; 17/808,169; 18/068,494; 13/013,740; 13/083,499; 13/632,731; 15/009,319; 15/211,822; 16/415,783; 16/415,796; 17/247,029 are incorporated herein by reference.

The above-described embodiments as well as additional and alternative embodiments are described in more detail herein. While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

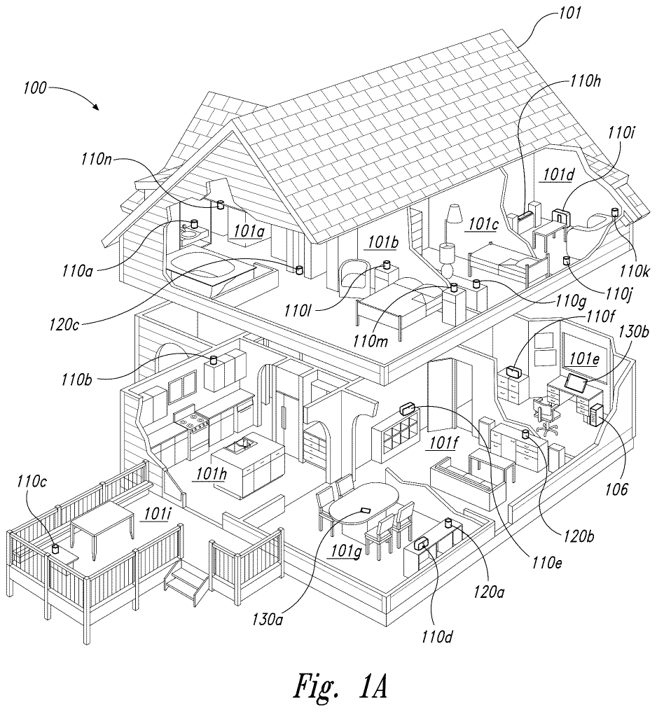

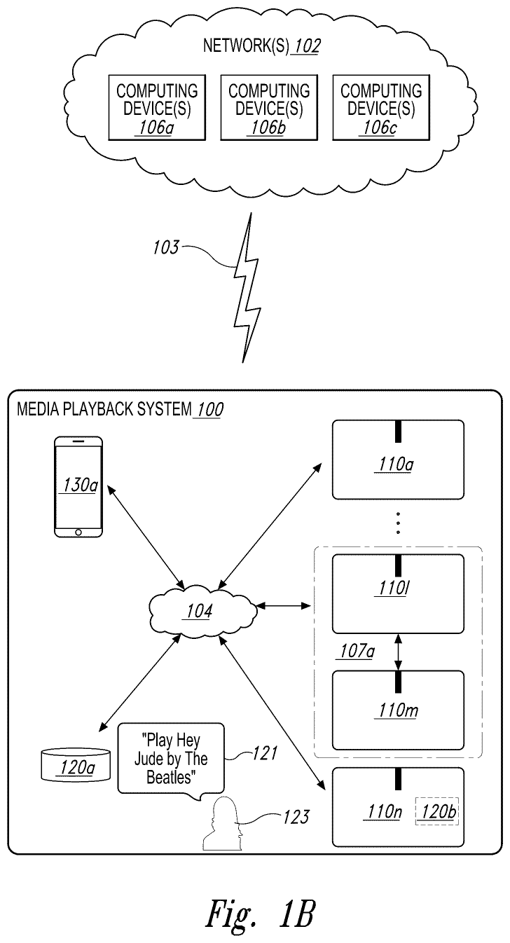

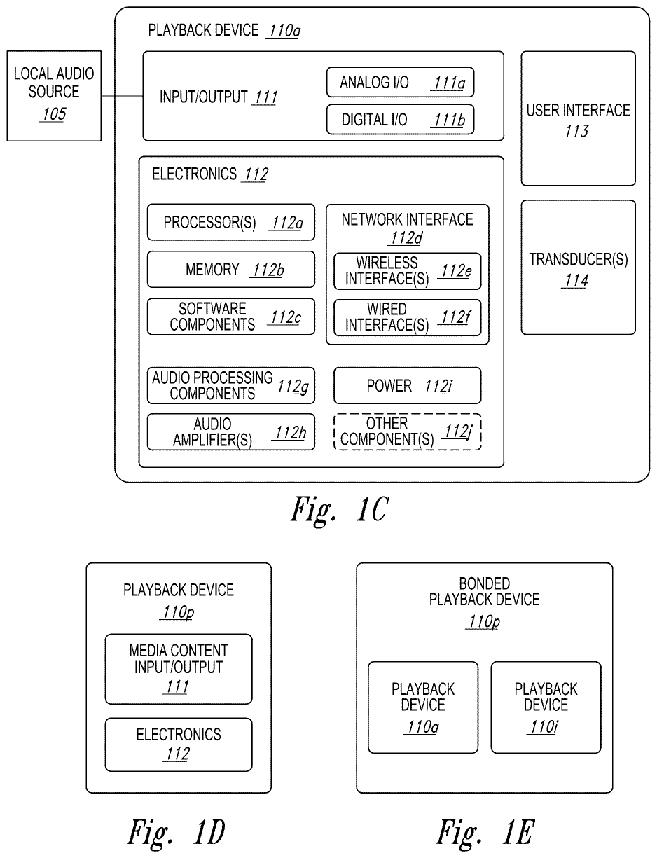

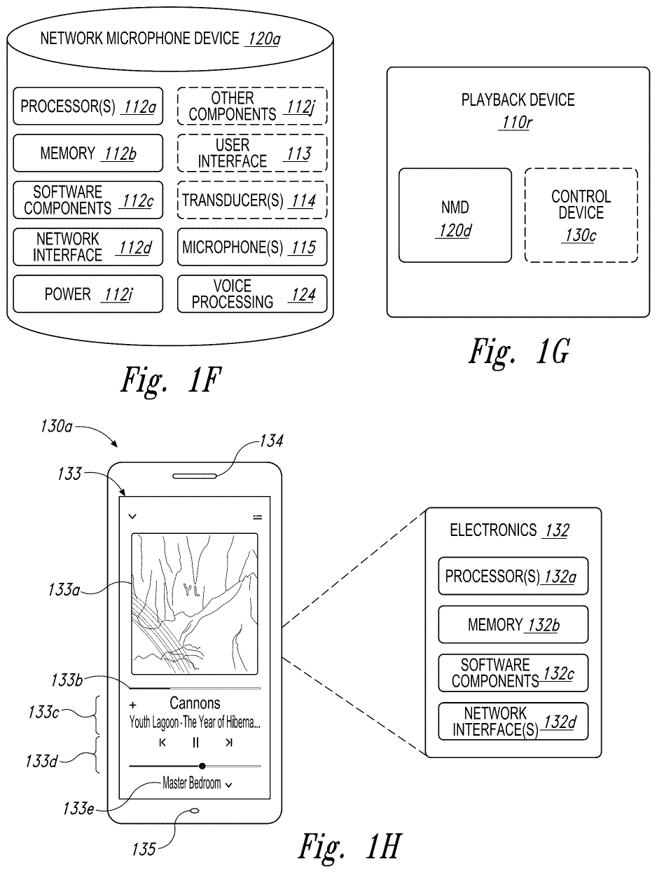

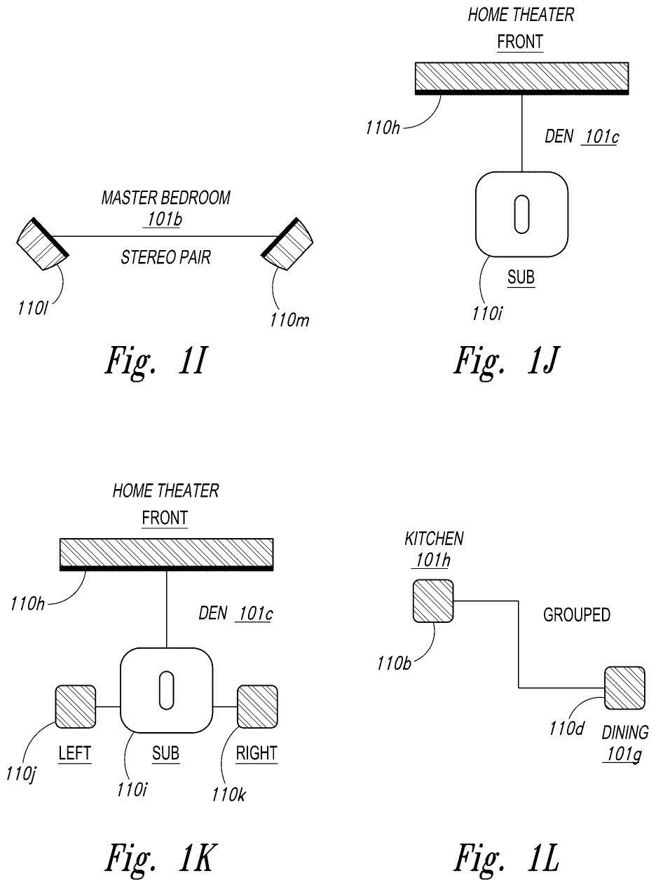

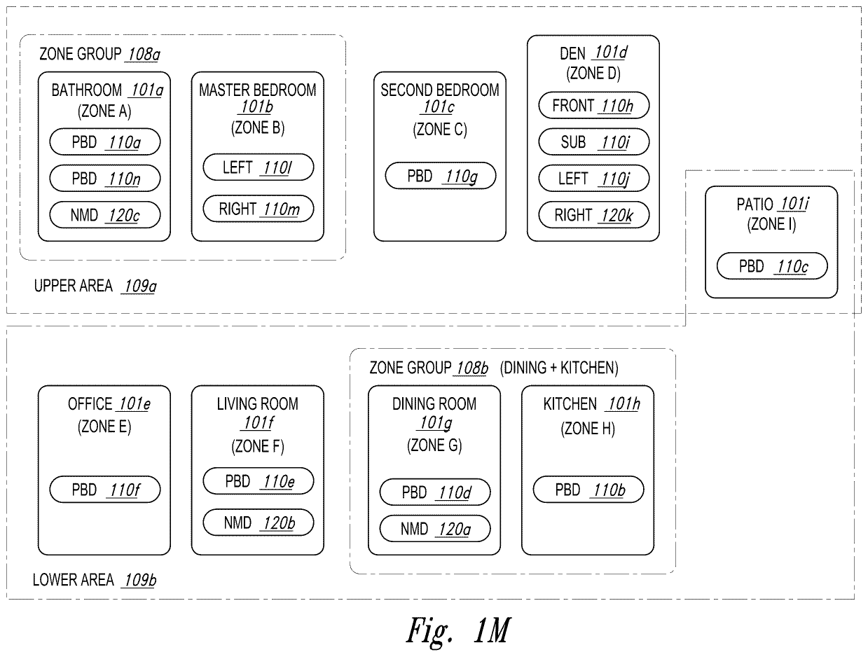

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1L.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the patio 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 1101 and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to, for example, FIGS. 1B and 1E and 11-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communications links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g. voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct connections, PANs, telecommunication networks, and/or other suitable communications links.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 1101 and 110m comprise a group 107a. The playback devices 1101 and 110m can be positioned in different rooms in a household and be grouped together in the group 107a on a temporary or permanent basis based on user input received at the control device 130a and/or another control device 130 in the media playback system 100. When arranged in the group 107a, the playback devices 1101 and 110m can be configured to play back the same or similar audio content in synchrony from one or more audio content sources. In certain embodiments, for example, the group 107a comprises a bonded zone in which the playback devices 1101 and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIG. 1-I through IM.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) transmit a corresponding command to the media playback system 100. In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110.

b. Suitable Playback Devices

FIG. 1C is a block diagram of the playback device 110a comprising an input/output 111. The input/output 111 can include an analog I/O 111a (e.g., one or more wires, cables, and/or other suitable communications links configured to carry analog signals) and/or a digital I/O 111b (e.g., one or more wires, cables, or other suitable communications links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises an High-Definition Multimedia Interface (HDMI) interface and/or cable. In some embodiments, the digital I/O 111b includes one or more wireless communications links comprising, for example, a radio frequency (RF), infrared, WiFi, Bluetooth, or another suitable communication protocol. In certain embodiments, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communications link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio information from an audio source (e.g., one or more of the computing devices 106a-c (FIG. 1B)), and/or another one of the playback devices 110. In some embodiments, the operations further include causing the playback device 110a to send audio information to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY: 1,” “PLAY: 3,” “PLAY: 5,” “PLAYBAR,” “PLAYBASE,” “CONNECT: AMP,”“CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

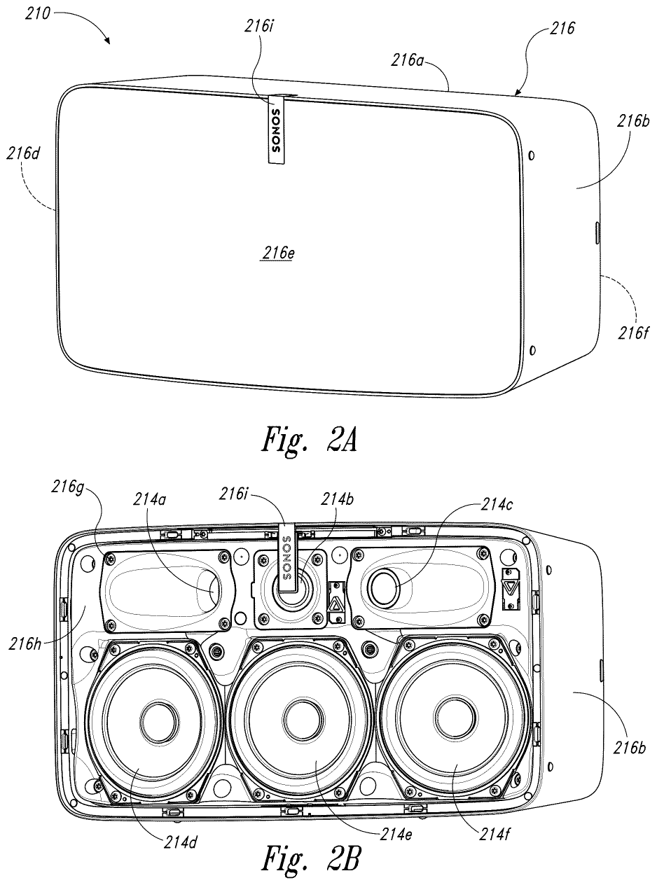

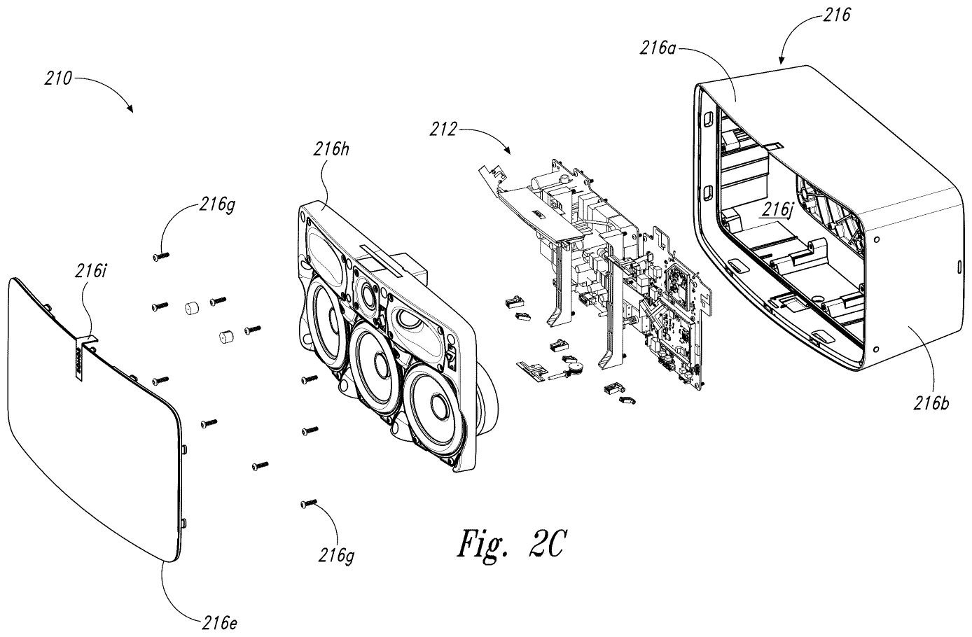

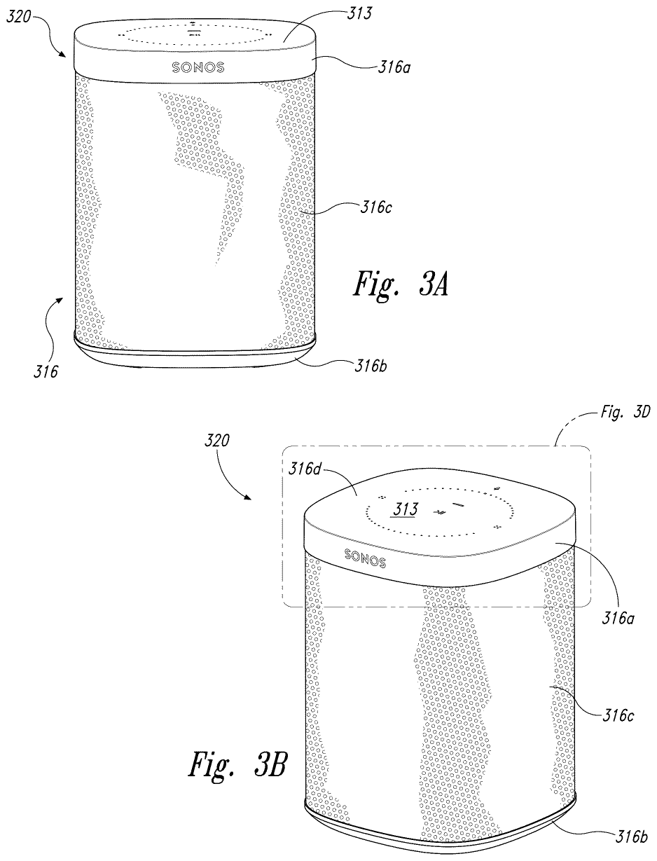

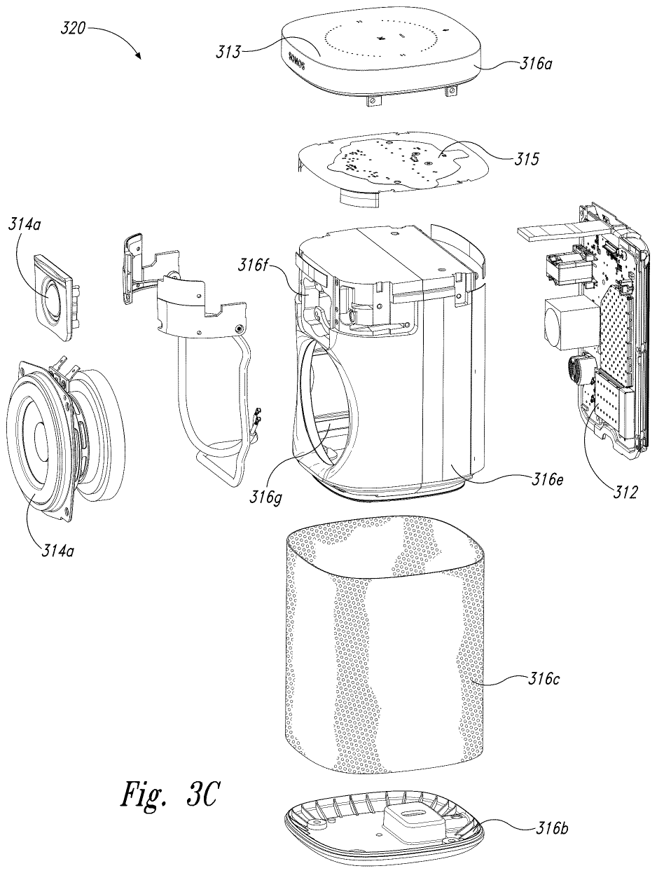

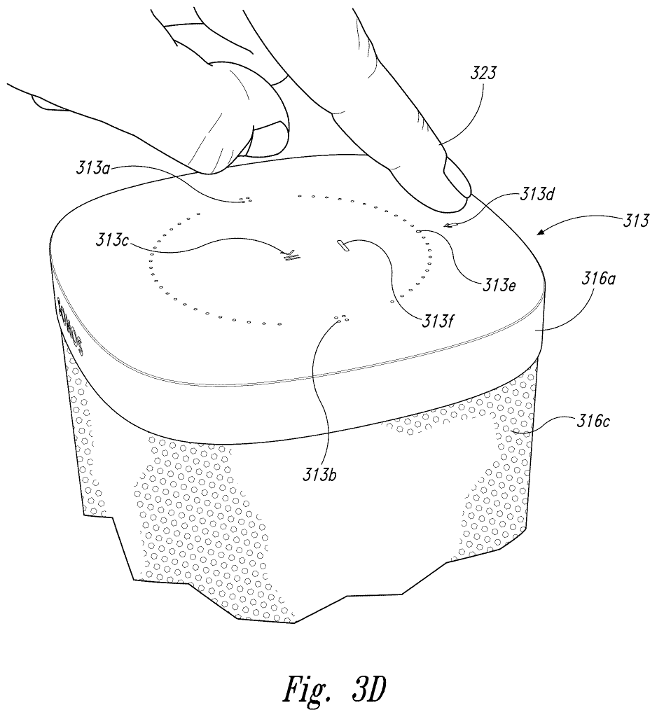

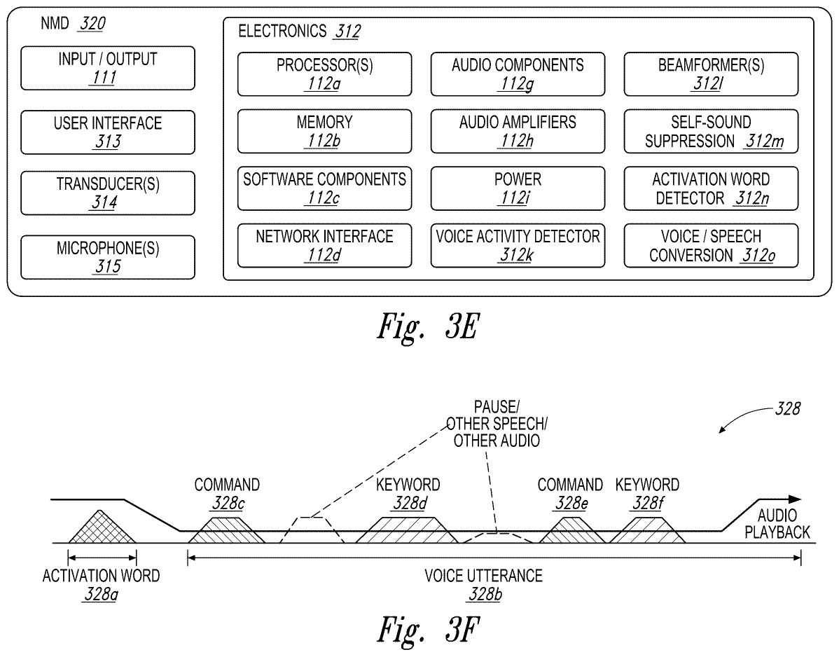

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 1101 and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device. Additional playback device embodiments are described in further detail below with respect to FIGS. 2A-3D.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio processing components 112g (FIG. 1C), the transducers 114, and/or other playback device components. In certain embodiments, the NMD 120a comprises an Internet of Things (IOT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B). Additional NMD embodiments are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE ® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

d. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of playback devices. The network interface 132d can also transmit and/or receive configuration changes such as, for example, adding/removing one or more playback devices to/from a zone, adding/removing one or more zones to/from a zone group, forming a bonded or consolidated player, separating one or more playback devices from a bonded or consolidated player, among others. Additional description of zones and groups can be found below with respect to FIG. 1-I through 1M.

The user interface 133 is configured to receive user input and can facilitate ‘control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

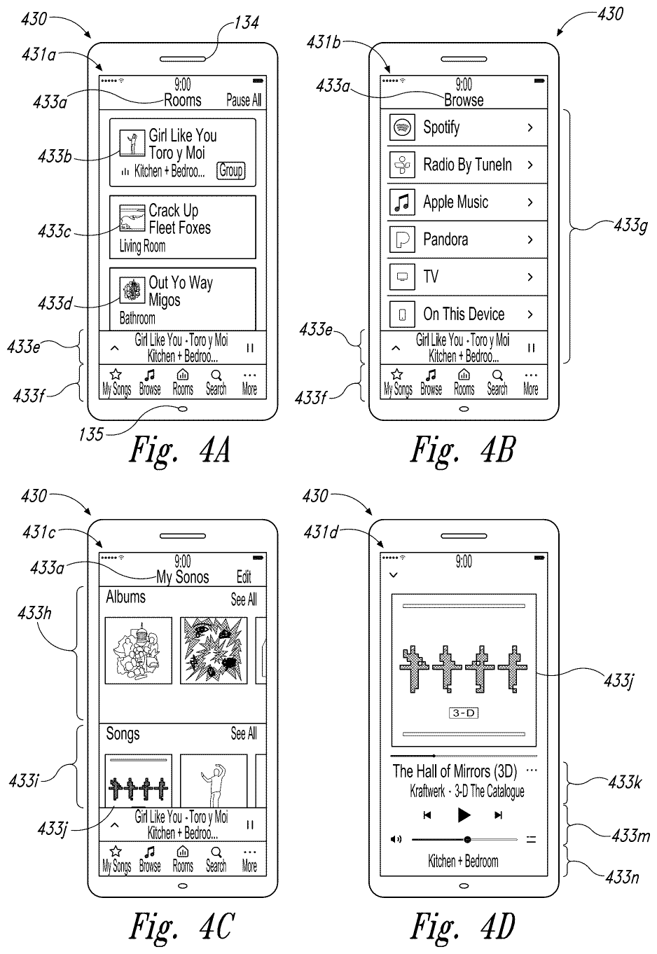

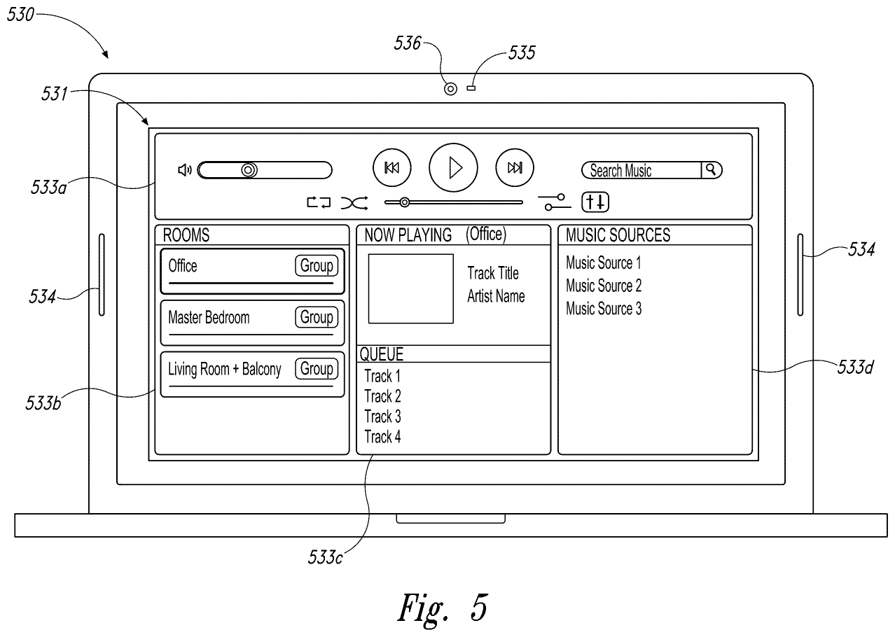

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones. Additional control device embodiments are described in further detail below with respect to FIGS. 4A-4D and 5.

e. Suitable Playback Device Configurations

FIGS. 1-1 through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 1101 (e.g., a left playback device) can be bonded to the playback device 1101 (e.g., a left playback device) to form Zone A. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110g and 110h can be merged to form a merged group or a zone group 108b. The merged playback devices 110g and 110h may not be specifically assigned different playback responsibilities. That is, the merged playback devices 110h and 110i may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1-I, the playback devices 1101 and 110m may be bonded so as to produce or enhance a stereo effect of audio content. In this example, the playback device 1101 may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured render low frequencies. When unbonded, however, the Front device 110h can be configured render a full range of frequencies. As another example, FIG. 1K shows the Front and SUB devices 110h and 110i further bonded with Left and Right playback devices 110j and 110k, respectively. In some implementations, the Right and Left devices 110j and 102k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can have be assigned a name such as “Dining +Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining +Kitchen zone group 108b. Other example zone variables and identifiers are described below.

In yet another example, the media playback system 100 may variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the media playback system 100 may not implement Areas, in which case the system may not store variables associated with Areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some embodiments, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other embodiments, however, the playback device 210 includes more than six transducers (e.g., nine, ten). Moreover, in some embodiments, all or a portion of the transducers 214 are configured to operate as a phased array to desirably adjust (e.g., narrow or widen) a radiation pattern of the transducers 214, thereby altering a user's perception of the sound emitted from the playback device 210.

In the illustrated embodiment of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some embodiments, however, the playback device 210 omits the filter 216i. In other embodiments, the playback device 210 includes one or more additional filters aligned with the transducers 214b and/or at least another of the transducers 214.

FIGS. 3A and 3B are front and right isometric side views, respectively, of an NMD 320 configured in accordance with embodiments of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes or apertures 316d in the upper portion 316a allow sound to pass through to one or more microphones 315 (FIG. 3C) positioned within the housing 316. The one or more microphones 316 are configured to received sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other embodiments, however, the NMD 320 includes a single transducer, or more than two (e.g., two, five, six) transducers. In certain embodiments, the NMD 320 omits the transducers 314a and 314b altogether.

Electronics 312 (FIG. 3C) includes components configured to drive the transducers 314a and 314b, and further configured to analyze audio information corresponding to the electrical signals produced by the one or more microphones 315. In some embodiments, for example, the electronics 312 comprises many or all of the components of the electronics 112 described above with respect to FIG. 1C. In certain embodiments, the electronics 312 includes components described above with respect to FIG. 1F such as, for example, the one or more processors 112a, the memory 112b, the software components 112c, the network interface 112d, etc. In some embodiments, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control). A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some embodiments, the user interface 313 includes additional or fewer control surfaces and illuminators. In one embodiment, for example, the user interface 313 includes the first indicator 313e, omitting the second indicator 313f. Moreover, in certain embodiments, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10 m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some embodiments, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson.” The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain embodiments, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 312l, acoustic echo cancellation (AEC) and/or self-sound suppression components 312m, activation word detector components 312n, and voice/speech conversion components 312o (e.g., voice-to-text and text-to-voice). In the illustrated embodiment of FIG. 3E, the foregoing components 312k-312o are shown as separate components. In some embodiments, however, one or more of the components 312k-312o are subcomponents of the processors 112a.

The beamforming and self-sound suppression components 312l and 312m are configured to detect an audio signal and determine aspects of voice input represented in the detected audio signal, such as the direction, amplitude, frequency spectrum, etc. The voice activity detector activity components 312k are operably coupled with the beamforming and AEC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise.

The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first-and third-party activation word detection algorithms are known and commercially available. For instance, operators of a voice service may make their algorithm available for use in third-party devices. Alternatively, an algorithm may be trained to detect certain activation words. In some embodiments, the activation word detector 312n runs multiple activation word detection algorithms on the received audio simultaneously (or substantially simultaneously). As noted above, different voice services (e.g. AMAZON's ALEXA®, APPLE's SIRI®, or MICROSOFT's CORTANA®) can each use a different activation word for invoking their respective voice service. To support multiple services, the activation word detector 312n may run the received audio through the activation word detection algorithm for each supported voice service in parallel.

The speech/text conversion components 312o may facilitate processing by converting speech in the voice input to text. In some embodiments, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include a activation word portion 328a and a voice utterance portion 328b. In some embodiments, the activation word 557a can be a known activation word, such as “Alexa,” which is associated with AMAZON's ALEXA®. In other embodiments, however, the voice input 328 may not include a activation word. In some embodiments, a network microphone device may output an audible and/or visible response upon detection of the activation word portion 328a. In addition or alternately, an NMB may output an audible and/or visible response after processing a voice input and/or a series of voice inputs.

The voice utterance portion 328b may include, for example, one or more spoken commands (identified individually as a first command 328c and a second command 328e) and one or more spoken keywords (identified individually as a first keyword 328d and a second keyword 328f). In one example, the first command 328c can be a command to play music, such as a specific song, album, playlist, etc. In this example, the keywords may be one or words identifying one or more zones in which the music is to be played, such as the Living Room and the Dining Room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some embodiments, the media playback system 100 is configured to temporarily reduce the volume of audio content that it is playing while detecting the activation word portion 557a. The media playback system 100 may restore the volume after processing the voice input 328, as shown in FIG. 3F. Such a process can be referred to as ducking, examples of which are disclosed in U.S. patent application Ser. No. 15/438,749, incorporated by reference herein in its entirety.

FIGS. 4A-4D are schematic diagrams of a control device 430 (e.g., the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (i.e., “Rooms”). A selected group region 433b displays audio content information (e.g., artist name, track name, album art) of audio content played back in the selected group and/or zone. Group regions 433c and 433d display corresponding group and/or zone name, and audio content information audio content played back or next in a playback queue of the respective group or zone. An audio content region 433e includes information related to audio content in the selected group and/or zone (i.e., the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (e.g., Spotify, Radio by Tunein, Apple Music, Pandora, Amazon, TV, local music, line-in) through which the user can browse and from which the user can select media content for play back via one or more playback devices (e.g., one of the playback devices 110 of FIG. 1A). Alternatively, if the user selects “My Sonos” in the lower display region 433f, the control device 430 can be configured to output a third user interface display 431c (FIG. 4C). A first media content region 433h can include graphical representations (e.g., album art) corresponding to individual albums, stations, or playlists. A second media content region 433i can include graphical representations (e.g., album art) corresponding to individual songs, tracks, or other media content. If the user selections a graphical representation 433j (FIG. 4C), the control device 430 can be configured to begin play back of audio content corresponding to the graphical representation 433j and output a fourth user interface display 431d fourth user interface display 431d includes an enlarged version of the graphical representation 433j, media content information 433k (e.g., track name, artist, album), transport controls 433m (e.g., play, previous, next, pause, volume), and indication 433n of the currently selected group and/or zone name.

FIG. 5 is a schematic diagram of a control device 530 (e.g., a laptop computer, a desktop computer). The control device 530 includes transducers 534, a microphone 535, and a camera 536. A user interface 531 includes a transport control region 533a, a playback status region 533b, a playback zone region 533c, a playback queue region 533d, and a media content source region 533e. The transport control region comprises one or more controls for controlling media playback including, for example, volume, previous, play/pause, next, repeat, shuffle, track position, crossfade, equalization, etc. The audio content source region 533e includes a listing of one or more media content sources from which a user can select media items for play back and/or adding to a playback queue.

The playback zone region 533b can include representations of playback zones within the media playback system 100 (FIGS. 1A and 1B). In some embodiments, the graphical representations of playback zones may be selectable to bring up additional selectable icons to manage or configure the playback zones in the media playback system, such as a creation of bonded zones, creation of zone groups, separation of zone groups, renaming of zone groups, etc. In the illustrated embodiment, a “group” icon is provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some embodiments, the control device 530 includes other interactions and implementations for grouping and ungrouping zones via the user interface 531. In certain embodiments, the representations of playback zones in the playback zone region 533b can be dynamically updated as playback zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the playback queue region 533d. The graphical representations may include track title, artist name, album name, album year, track length, and other relevant information that may be useful for the user to know when controlling the media playback system 100 via the user interface 531.

The playback queue region 533d includes graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device. In some embodiments, for example, a playlist can be added to a playback queue, in which information corresponding to each audio item in the playlist may be added to the playback queue. In some embodiments, audio items in a playback queue may be saved as a playlist. In certain embodiments, a playback queue may be empty, or populated but “not in use” when the playback zone or zone group is playing continuously streaming audio content, such as Internet radio that may continue to play until otherwise stopped, rather than discrete audio items that have playback durations. In some embodiments, a playback queue can include Internet radio and/or other streaming audio content items and be “in use” when the playback zone or zone group is playing those items.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped.

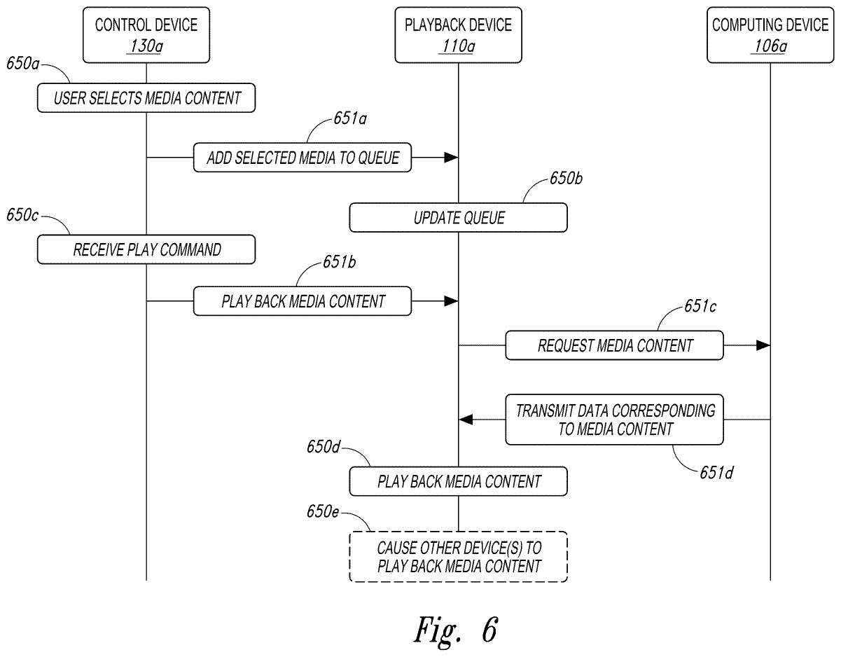

FIG. 6 is a message flow diagram illustrating data exchanges between devices of the media playback system 100 (FIGS. 1A-1M).

At step 650a, the media playback system 100 receives an indication of selected media content (e.g., one or more songs, albums, playlists, podcasts, videos, stations) via the control device 130a. The selected media content can comprise, for example, media items stored locally on or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 130a transmits a message 651a to the playback device 110a (FIGS. 1A-1C) to add the selected media content to a playback queue on the playback device 110a.

At step 650b, the playback device 110a receives the message 651a and adds the selected media content to the playback queue for play back.

At step 650c, the control device 130a receives input corresponding to a command to play back the selected media content. In response to receiving the input corresponding to the command to play back the selected media content, the control device 130a transmits a message 651b to the playback device 110a causing the playback device 110a to play back the selected media content. In response to receiving the message 651b, the playback device 110a transmits a message 651c to the first computing device 106a requesting the selected media content. The first computing device 106a, in response to receiving the message 651c, transmits a message 651d comprising data (e.g., audio data, video data, a URL, a URI) corresponding to the requested media content.

At step 650d, the playback device 110a receives the message 651d with the data corresponding to the requested media content and plays back the associated media content.

At step 650e, the playback device 110a optionally causes one or more other devices to play back the selected media content. In one example, the playback device 110a is one of a bonded zone of two or more players (FIG. 1M). The playback device 110a can receive the selected media content and transmit all or a portion of the media content to other devices in the bonded zone. In another example, the playback device 110a is a coordinator of a group and is configured to transmit and receive timing information from one or more other devices in the group. The other one or more devices in the group can receive the selected media content from the first computing device 106a, and begin playback of the selected media content in response to a message from the playback device 110a such that all of the devices in the group play back the selected media content in synchrony.

### IV. Overview of Example Embodiments

As mentioned above, aspects of the disclosed embodiments include groupwise playback of multichannel audio content, including (i) playing one or more channels of multichannel audio content according to one of several different delay schemes and/or (ii) causing one or more channels of multichannel audio content to be played according to one of several different delay schemes. The delay schemes include a lip synchrony delay scheme, a standard delay scheme, and a sound steering delay scheme.

In operation, playback devices according to disclosed embodiments are configured to play audio content according to one of the several different delay schemes based on whether the audio content (i) does not have corresponding video content, (ii) has corresponding video content, (iii) has corresponding video content and includes voice dialog, (ii) has corresponding video content but does not include voice dialog.

### V. Technical Features

In some embodiments, at least some aspects of the technical solutions derive from the technical structure and organization of the audio content, the playback timing, and clock timing that the playback devices use to play audio from media sources (i) in lip synchrony with corresponding video content, (ii) in synchrony with each other, (iii) in a sound steering scheme, and/or (iv) in some other groupwise fashion. An understanding of how playback devices generate and/or use playback timing based on clock timing and play audio based on playback timing and clock timing is also helpful to understand aspects of the disclosed embodiments.

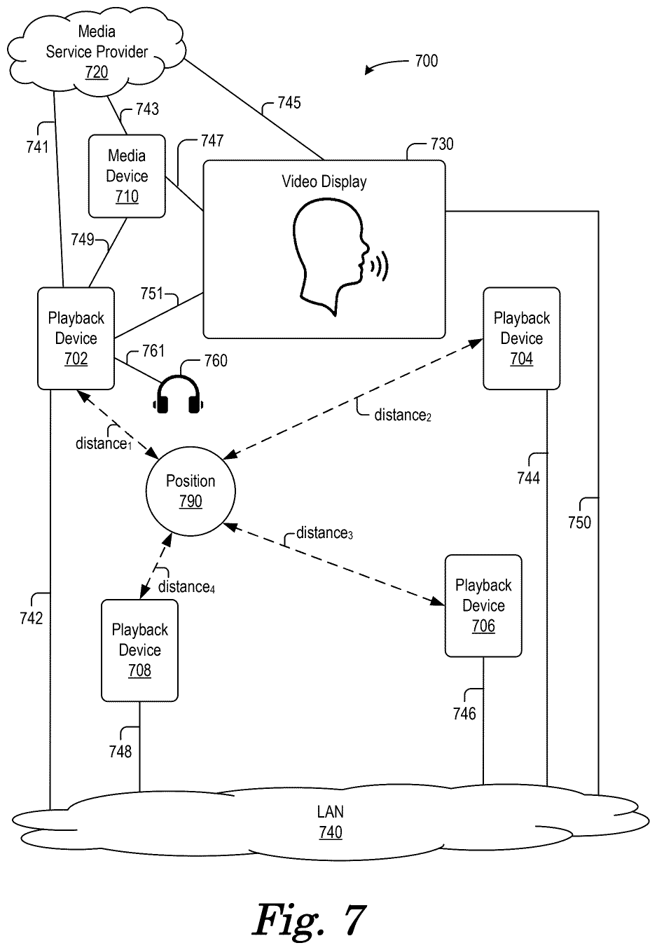

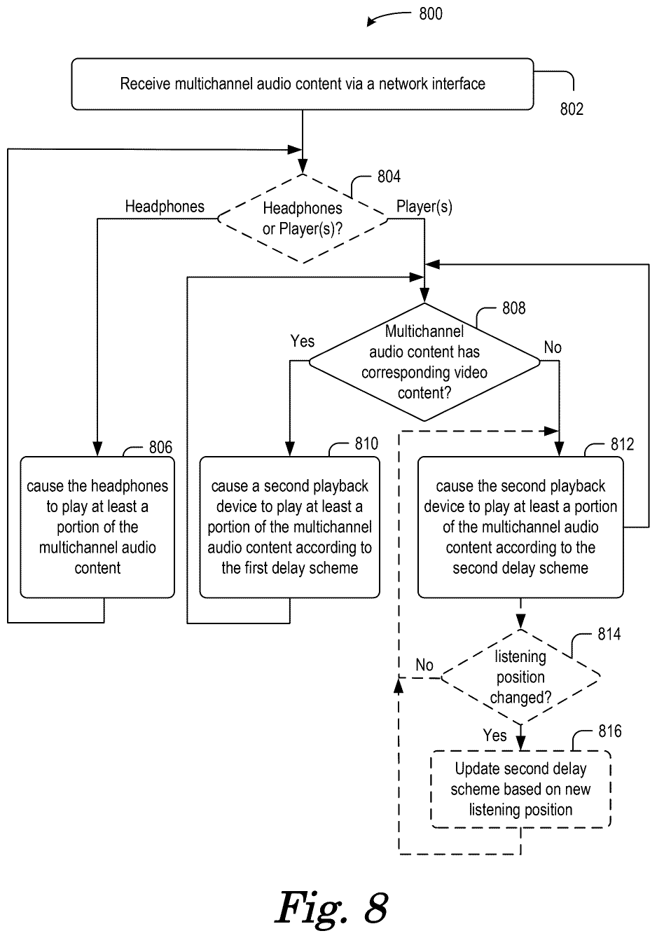

Therefore, to aid in understanding certain aspects of the disclosed technical solutions, certain technical details of the audio content, playback timing, and clock timing, as well as how playback devices generate and/or use playback timing and clock timing for playing audio are described below. Except where noted, the technical details of the audio content, playback timing, and clock timing described herein are the same or substantially the same for the examples shown and described herein with reference to FIGS. 7 and 8.

a. Audio Content

The audio content referred to herein may be any type of audio content now known or later developed that is received from a media source.

For example, in some embodiments, the audio content includes any one or more of: (i) streaming music or other audio obtained from a streaming media service, such as Sonos Radio, Spotify, Pandora, or other streaming media services; (ii) streaming music or other audio from a local music library, such as a music library stored on a user's laptop computer, desktop computer, smartphone, tablet, home server, or other computing device now known or later developed; (iii) audio content associated with video content, such as audio content associated with a television program or movie, audio content associated with a video game, or audio content associated with any other type of audiovisual media received from local audiovisual source, a streaming video service, or any other source of audiovisual content now known or later developed; (iv) text-to-speech or other audible information from a voice assistant service (VAS), such as Amazon Alexa or other VAS services now known or later developed; (v) audio content from a telephone, video phone, video/teleconferencing system or other application configured to allow users to communicate with each other via audio and/or video; and/or (vi) algorithmically-generated media content (known as “generative audio,” “generative media content,” “artificial intelligence (AI) content”). Aspects of generative audio, generative media, and AI content are disclosed and described in further detail in Int'l App. PCT/US2021/072454 titled “Playback of Generative Media Content,” filed on Nov. 17, 2021, published on May 27, 2022, as Int'l Pub. WO 2022/109556. Int'l App PCT/US2021/072454 claims priority to (i) U.S. application Ser. No. 17/302,690 titled “Playback of Generative Media Content,” filed on May 10, 2021, and currently pending, (ii) U.S. Provisional App. 63/198,866 titled “Multi-Device Playback of Generative Media Content,” filed on Nov. 18, 2020, and now expired, and (iii) U.S. Provisional App. 63/261,893 titled “Multi-Channel Playback of Generative Media Content,” filed on Sep. 30, 2021, and now expired. The entire contends of PCT/US2021/072454; Ser. No. 17/302,690; 63/198,866; and 63/261,893 are incorporated herein by reference.

In some embodiments, a home theater primary (which may also be a group coordinator), sometimes referred to as a “sourcing” device herein, obtains any of the aforementioned types of audio and/or audiovisual content from a media source via an interface on the sourcing device. The interface may be any of a “line-in” analog interface, a digital audio interface, a network interface (e.g., a WiFi, Bluetooth, HDMI, USB-A/B/C, FireWire, Thunderbolt or other interface), or any other interface on the sourcing device suitable for receiving audio and/or audiovisual content in digital or analog format now known or later developed. In some examples, the home theater primary comprises several interfaces among which the primary is configured to select from automatically and/or via manual input. In certain examples, for instance, the home theater primary is configured to distribute audio received via an interface to one or more satellites but otherwise lacks audio transducers, amplifiers, and other electronics typically involved with audio output.

A media source is any system, device, or application that generates, provides, or otherwise makes available any of the aforementioned audio and/or audiovisual content to a sourcing device, including but not limited to a playback device, a smartphone, a tablet computer, a smartwatch, a network server, a content service provider, or other computing system or device now known or later developed that is suitable for providing audio and/or audiovisual content to a playback device.

As mentioned earlier, a playback device that receives or otherwise obtains audio content from a media source for playback and/or distribution to another playback device in a playback group (e.g., a home theater bonded zone, a paired configuration, a stereo pair configuration, or any other configuration of two or more playback devices) is sometimes referred to herein as the “sourcing” device for the playback group. One function of the sourcing device of a playback group is to process received audio content for playback and/or distribution to group members of the playback group for groupwise playback.

In some embodiments, the sourcing device transmits the processed audio content to all the other group members in the playback group. In some embodiments, the sourcing device transmits the audio content to a multicast network address, and all the group members configured to play the audio (i.e., the group members of the playback group) receive the audio content via that multicast address.

In some embodiments, the audio sourcing device receives audio content from a media source in digital form, e.g., via a stream of packets. In some embodiments, individual packets in the stream have a sequence number or other identifier that specifies an ordering of the packets. In operation, the audio sourcing device uses the sequence number or other identifier to detect missing packets and/or to reassemble the packets of the stream in the correct order before performing further processing. In some embodiments, the sequence number or other identifier that specifies the ordering of the packets is or at least comprises a timestamp indicating a time when the packet was created. The packet creation time can be used as a sequence number based on an assumption that packets are created in the order in which they should be subsequently played out.

For example, in some embodiments, individual packets of audio content from a media source may include both a timestamp and a sequence number. The timestamp is used to place the incoming packets of audio content in the correct order; the sequence number can be used to detect packet losses. In operation, the sequence numbers increase by one for each Real-time Transport Protocol (RTP) packet transmitted from the media source, and timestamps increase by the time “covered” by an RTP packet. In instances where a portion of audio content is split across multiple RTP packets, multiple RTP packets can have the same timestamp.

In some embodiments, the audio sourcing device does not change the sequence number or identifier of a received packet during processing. In some embodiments, the audio sourcing device reorders at least a first set of packets in a first packet stream received from an audio source (an inbound stream) based on each packet's sequence identifier, extracts audio content from the received packets, reassembles a bitstream of audio content from the received packets, and then repacketizes the reassembled bitstream into a second set of packets (an outbound stream), where packets in the second set of packets have sequence numbers and/or timestamps that differ from the sequence numbers and/or timestamps of the packets in the first set of packets (or first stream). The audio content in this outbound stream is sometimes referred to herein as processed audio content.

In some embodiments, individual packets in the second stream are a different length (i.e., shorter or longer) than individual packets in the first stream. In some embodiments, reassembling a bitstream from the incoming packet stream and then subsequently repacketizing the reassembled bitstream into a different set of packets facilitates both (i) uniform processing and/or transmission of the processed audio content by the audio sourcing device and (ii) uniform processing by the group members that receive the processed audio content from the audio sourcing device. However, for some delay-sensitive audio content, reassembly and repacketization may be undesirable, and therefore, in some embodiments, the audio sourcing device may not perform reassembly and repacketization for some (or all) audio content that it receives before playing the audio and/or transmitting the audio content to other playback devices/group members.

b. Playback Timing

In some embodiments, the playback devices disclosed and described herein use playback timing to play audio in synchrony with each other and/or in lip synchrony with corresponding video content. An individual playback device can generate playback timing and/or play back audio according to playback timing, based on the playback device's configuration in the playback group. The audio sourcing playback device (acting as a home theater primary, stereo pair primary and/or a group coordinator in some instances) that generates the playback timing for the processed audio content also transmits that generated playback timing to all the other playback devices in the playback group, i.e., all of the playback devices that are configured to play the audio content together in a groupwise fashion with each other (e.g., the home theater satellites, stereo pair secondary and/or other group members).

For example, in a home theater bonded zone according to some embodiments, e.g., a home theater configuration comprising a home theater primary and one or more home theater satellites, the home theater primary (i) obtains the audio content from a media source (ii) processes the audio content and generates the playback timing for the processed audio content, and (iii) transmits the processed audio content and the playback timing to the one or more home theater satellites.

In some embodiments, the audio sourcing device (which, again, may be the home theater primary in a home theater bonded zone, but could alternatively be a home theater satellite in some implementations) transmits playback timing together with the audio content to the playback group members. In some embodiments, the audio sourcing device transmits playback timing to the playback group members separately from the processed audio content.

In some embodiments, the audio sourcing device transmits the playback timing to all the group members by transmitting the playback timing to a multicast network address for the playback group, and all the group members receive the playback timing via the playback group's multicast address. In some embodiments, the audio sourcing device transmits the playback timing to each group member individually by transmitting the playback timing to each group member's unicast network address.

In some embodiments, the playback timing is generated for individual frames (or packets) of processed audio content. As described above, in some embodiments, the processed audio content is packaged in a series of frames (or packets) where individual frames (or packets) comprise a portion of the audio content. In some embodiments, the playback timing for the audio content includes a playback time for each frame (or packet) of audio content. In some embodiments, the playback timing for an individual frame (or packet) is included within the frame (or packet), e.g., in the header of the frame (or packet), in an extended header of the frame (or packet), and/or in the payload portion of the frame (or packet).

In some embodiments, the playback time for an individual frame (or packet) is identified within a timestamp or other indication. In such embodiments, the timestamp (or other indication) represents a time to play the one or more portions of audio content within that individual frame (or packet).

In operation, when the playback timing for an individual frame (or packet) is generated, the playback timing for that individual frame (or packet) is a future time relative to a current clock time of a reference clock at the time that the playback timing for that individual frame (or packet) is generated.

In operation, a playback device tasked with playing particular audio content will play the portion(s) of the particular audio content within an individual frame (or packet) at the playback time specified by the playback timing for that individual frame (or packet), as adjusted to accommodate for differences between the clock timing and a clock at the playback device that is tasked with playing the audio content, as described in more detail herein.

c. Clock Timing

The playback devices disclosed and described herein use clock timing to generate playback timing for audio content and/or to play audio based on the audio content and the generated playback timing.

In some embodiments, the audio sourcing device uses clock timing from a reference clock (e.g., a device clock, a digital-to-audio converter clock, a playback time reference clock, or any other clock) to generate playback timing for audio content that the audio sourcing device receives from a media source. The reference clock can be a “local” clock at the audio sourcing device or a “remote” clock at a separate network device, e.g., another playback device, a computing device, or another network device configured to provide clock timing for use by (i) an audio sourcing device to generate playback timing and/or (ii) the audio sourcing device and group member(s) to play audio based on the playback timing associated with the audio content. In some examples, for instance, the remote clock may include one or more clocks of one or more cloud servers.

In some embodiments, each playback device tasked with playing particular audio content in synchrony (i.e., all the group members in a playback group, e.g., a home theater bonded zone) use the same clock timing from the same reference clock to play back that particular audio content in synchrony with each other. In some embodiments, the playback devices use the same clock timing to play audio content that was used to generate the playback timing for the audio content. The reference clock may be a local clock of the audio sourcing device, but the reference clock could also be a clock at a different device, such as a group member or a computing device (e.g., a smartphone, tablet computer, smartwatch, or other computing device).

In some embodiments, the device that generates the clock timing also transmits the clock timing to all the playback devices that need to use the clock timing for generating playback timing and/or playing back audio. In some embodiments, the device that generates the clock timing (e.g., the audio sourcing device, which may be a home theater primary and/or a group coordinator in some embodiments) transmits the clock timing to a multicast network address, and all the playback devices in the playback group receive the clock timing via that multicast address. In some embodiments, the device that generates the clock timing alternatively transmits the clock timing to each unicast network address of each playback device in the playback group.

In some home theater embodiments, the device that generates the clock timing for a home theater bonded zone is the playback device configured to operate as the audio sourcing device for the home theater bonded zone, which is typically (but not necessarily always) the home theater primary for the home theater bonded zone. And in operation, the audio sourcing device of the home theater bonded zone transmits the clock timing to the other playback device(s) in the home theater bonded zone. For example, when the home theater bonded zone includes a home theater primary and one or more home theater satellites, the home theater primary operates as the audio sourcing device, and the home theater primary transmits clock timing to the one or more home theater satellites.

The audio sourcing device (e.g., home theater primary) and the group member(s) (e.g., home theater satellite(s)) each use the clock timing and the playback timing to play audio in a groupwise manner. In some example embodiments, the audio sourcing device and the group member(s) each use the clock timing and the playback timing to play audio in synchrony with each other and/or in lip synchrony with corresponding video content.

Further, in some embodiments, the audio sourcing device (e.g., home theater primary) and the group member(s) (e.g., home theater satellite(s)) each use the clock timing and the playback timing to play different channels of audio. In an example home theater bonded zone configuration with a soundbar configured as the home theater primary, two playback devices configured as left and right rear satellites, and a subwoofer, (i) the soundbar (home theater primary) plays left front, right front, and center channels, (ii) the left and right rear playback devices (home theater satellites) play left rear and right rear channels, respectively, and (iii) the subwoofer plays a subwoofer channel.

In some embodiments, one or both of the audio sourcing device and the group member use the clock timing information to determine one or more of (i) a difference between the clock time of the audio sourcing device and the group member (and/or vice versa), (ii) a difference between the clock rate of the audio sourcing device and the group member (and/or vice versa), and (iii) whether and the extent to which the clock rate of the audio sourcing device has drifted relative to the clock rate of the group member (and/or vice versa). In some embodiments, one or both of the audio sourcing device and the group member use the determined difference(s) between the clock times, clock rates, and/or clock drift to adjust the sample rate of the audio to be played in connection with playing the audio content in a groupwise fashion with each other.

For example, in combination with generating playback timing and adjusting playback timing described below, some embodiments additionally include using the clock timing differences to facilitate one or both of (i) dropping one or more samples of audio, e.g., not sending and/or not playing the dropped samples, thus effectively skipping those samples, and/or (ii) adding one or more samples of audio, e.g., sending samples with no content and/or injecting small periods of silence (typically less than 15-20 milliseconds) during playback. Adjusting the sample rate of the audio to be distributed and/or played based on differences in clock times, clock rates, and/or clock drift between the audio sourcing device and the group member can in some instances facilitate the groupwise playback process by helping to account for differences in the clock times, clock rates, and/or clock drift instead of or in addition to the timing offsets and timing advances described further herein in connection with generating playback timing and playing audio based on the generated playback timing.

In some instances, dropping one or more samples of audio and/or adding one or more samples of audio in the manner described above can also facilitate transitioning between playing audio content according to the lip synchrony scheme to playing audio content according to the standard and/or sound steering scheme (and vice versa). Details of the lip synchrony, standard, and sound steering schemes are described in detail herein.

d. Generating Playback Timing

In some embodiments, the audio sourcing device: (i) generates playback timing for audio content based on clock timing from a “reference clock” (which may be a local clock at the audio sourcing device), and (ii) transmits the generated playback timing to the group member(s) in the playback group.

In operation (and as described further herein), each playback device in the playback group (e.g., a home theater bonded zone) plays the audio content according to playback timing. Each playback device in a playback group playing the same audio content according to the playback timing generated by the audio sourcing device is sometimes referred to herein as a playback group playing audio content in a groupwise fashion and/or in synchrony with each other.

When generating playback timing for an individual frame (or packet), the audio sourcing device adds a “timing advance” to a current clock time of a “reference clock” that is used for generating the playback timing. In some embodiments, the “reference clock” is a local device clock (or similar) at the audio sourcing device, and adding the timing advance to the current reference clock time includes adding the timing advance to a current clock time of the local clock at the audio sourcing device that the audio sourcing device is using for generating the playback timing.

Embodiments disclosed herein include generating playback timing according to several different delay schemes, including (i) a standard scheme, (ii) a lip synchrony scheme, and (iii) a sound steering scheme. Each delay scheme involves using timing advances of different durations.

In some embodiments, the timing advances used for the different delay schemes are based on one or more of (i) wireless propagation time between the audio sourcing device and the other playback devices within the playback group, or (ii) sound wave propagation time between (ii-a) a listening position within a listening area and (ii-b) each playback device within the playback group.

i. Generating Playback Timing for the Standard Scheme

The standard scheme includes using timing advances from as low as 20 milliseconds up to several hundred milliseconds or even a few seconds. For the standard scheme, if the current reference clock time is t, and the timing advance is 100 milliseconds, then the playback time for a specific packet or frame of audio content is 100 milliseconds in the future from the current clock time of the reference clock, i.e., the playback time for that specific packet=t+100 milliseconds. Compared to a shorter timing advance (e.g., 10-20 milliseconds), a longer timing advance (e.g., 100-300 milliseconds, or even a few seconds) allows more time for packets of audio content to be (i) transmitted from the audio sourcing device to all of the playback devices in the playback group and (ii) processed and played by each of the playback devices in the playback group. Using longer timing advances (i.e., a greater delay) to generate playback timing enables the playback devices in the playback group to build up buffers of audio content that can help guard against temporary dropouts that might otherwise be caused by short term network congestion or other problems, thereby enabling more reliable playback as compared to using shorter timing advances (i.e. a shorter delay).

ii. Generating Playback Timing for the Lip Synchrony Scheme

In addition to playing the audio content in synchrony with each other, the playback devices in a home theater bonded zone should also play audio having corresponding video content in lip synchrony with display of the corresponding video content by a display device (e.g., a television, computer monitor, or other display screen).

In practice, audiovisual content typically has frames of video and frames of audio that are time-synchronized with each other such that each frame (or set of frames) of video has a corresponding frame (or set of frames) of audio. Accordingly, embodiments disclosed herein implement a lip synchrony scheme when playing audio that has corresponding video content, e.g., when playing audio that is part of a television program, movie, video game, or other content where it is desirable to play the audio content in lip synchrony with playback of corresponding video.

To play audio content in lip synchrony with display of the audio content's corresponding video content, a playback device should play each frame(s) of audio content as close as possible to the same time that a video display (e.g., a television, monitor, or similar display device) plays the frame(s) of video corresponding to those frame(s) of audio.

Because the audio sourcing device (e.g., the home theater primary) must generate playback timing for audio content and distribute the audio content and the playback timing to the group members (e.g., the home theater satellites) before the group members can play the audio content, playback of the audio by the playback devices is rarely (if ever) at exactly the same time as playback of the corresponding video frames by the display device.

However, testing has shown that humans will perceive audio to be in lip synchrony with corresponding video as long as playback of the audio lags playback of the video by no more than about 20-22 milliseconds.

Thus, for audio content having corresponding video content, a playback device playing one or more frames of audio content within about 20-22 milliseconds after a video display has played one or more corresponding frames of video content is sometimes referred herein as the playback device playing the audio content in lip synchrony with the corresponding video content. Accordingly, while a longer timing advance/delay (e.g., 100-300 milliseconds) may allow more time for transmitting, receiving, processing, and playing audio, a shorter timing advance/delay (e.g., between 10-20 milliseconds) is desirable when generating playback timing for audio that has corresponding video to facilitate playing the audio in lip synchrony with the corresponding video content.

iii. Generating Playback Timing for the Sound Steering Scheme

Additionally, in some embodiments, it may be desirable for the audio sourcing device (e.g., the home theater primary) to generate separate playback timing for each group member (e.g., the home theater satellites) based on a desired listening position. In operation, generating separate playback timing for each playback device entails using a different timing advance (i.e., a different delay) when generating the playback timing for each playback device. By generating playback timing for each playback device individually, the audio sourcing device is able to “steer” the sound in a listening area to a particular listening position. In other words, by controlling when each playback device in the playback group plays a particular frame of audio content, the audio sourcing device can control when audio emitted by each playback device arrives at a target listening position within the listening area.

For example, consider a home theater bonded zone configuration that includes a left playback device on the left side of the listening area and a right playback device on the right side of the listening area. When a detected and/or desired listening position is closer to the left playback device than the right playback device, the audio sourcing device can use a shorter timing advance when generating the playback timing for the right playback device than the timing advance used for generating the playback timing for the left playback device.

For example, the speed of sound is approximately 343 m/s or, stated differently, 3 milliseconds elapsed per meter traveled. If the target listening position is 1 meter from the left front playback device and 3 meters from the right front playback device, the audio sourcing device can use a timing advance of 56 milliseconds when generating the playback timing for the audio content to be played from the left front playback device and a timing advance of 50 milliseconds when generating the playback timing for the audio content to be played from the right front playback device.

Because the target listening position is 2 meters further from the right front playback device than the left front playback device, and because sound travels approximately 1 meter every 3 milliseconds, if the left playback device and the right playback device played the same audio at substantially the same time, the sound emitted by the right playback device would arrive at the target listening position approximately 6 milliseconds after the sound emitted by the left playback device. So by using a timing advance for the right playback device that is 6 milliseconds shorter than the timing advance for the left playback device, the audio sourcing device can cause the same direct audio played by the left front playback device and the right front playback device to arrive at the target listening position at approximately the same time. Here, the direct audio played by the left front playback device corresponds to the audio emitted from the left front playback device; some indirect audio (i.e., direct audio reflected from the walls, ceiling, floor, and/or other surfaces in the listening area) may nevertheless arrive at different times.

Steering the audio within the listening area by using different playback timing for each playback device tends to enhance the stereo effect experienced by the listener when listening to stereo audio. Similarly, steering the audio within the listening area by using different playback timing for each playback device tends to enhance the immersive surround sound effect experienced by the listener when listening to spatial audio (e.g., Dolby Atmos, DTS: X, Sony 360 Reality Audio).

iv. Determining Timing Advances for Generating Playback Timing

In some embodiments, the audio sourcing device determines one or more timing advance(s) by sending one or more test packets to the group member(s), and then receiving test response packets back from the group member(s). In some embodiments, the audio sourcing device and the group member(s) negotiate one or more timing advances via multiple test and response messages. In some embodiments with more than two group members, the audio sourcing device determines a timing advance by exchanging test and response messages with all of the group members, and then setting a timing advance that is sufficient for the group member having the longest total of network transmit time and packet processing time, within the upper bounds that are acceptable for the type of audio content to be played. In this manner, the timing advances used for the lip synchrony scheme, the standard scheme, and the sound steering scheme are based at least in part on wireless propagation times between the playback devices.

For example, in a home theater bonded zone implementation where the home theater bonded zone is playing audio that has corresponding video content, the home theater primary and the home theater satellites may negotiate a timing advance that is no greater than about 15-17 milliseconds. Alternatively, rather than negotiating a timing advance, some embodiments may instead set the timing advance to some fixed value, e.g., 10 or 15 milliseconds.

In another example home theater bonded zone implementation where the home theater bonded zone is playing audio that does not have corresponding video content (e.g., the home theater bonded zone is playing music from an online streaming source), the home theater primary and the home theater satellites may negotiate a timing advance that is between 50-100 milliseconds. Alternatively, rather than negotiating a timing advance, some such embodiments may instead set the timing advance to some fixed value, e.g., 50, 75, or 100 milliseconds or perhaps some other fixed value.

In examples that use playback timing to steer sound within a listening area, the home theater primary may negotiate a separate timing advance with each home theater satellite based on the position of that home theater satellite relative to the desired listening position within the listening area, where the set of timing advances used for the different playback devices in the playback group cause audio played by the playback devices in the playback group to arrive at the desired listening position within the listening area at substantially the same time. In this manner, the timing advances used for the sound steering scheme are based at least in part on sound wave propagation times.

v. Changing Timing Advances to Switch Between Delay Schemes

In some embodiments, the audio sourcing device can switch between using different timing advances when playing different types of audio content. For example, in some embodiments, the audio sourcing device uses a short timing advance when generating playback timing for audio that has corresponding latency-sensitive video content. When a user switches from watching television to listening to music (and the audio content is therefore switched from audio content that has corresponding video to content to audio content that does not have corresponding video content), the audio sourcing device switches to using a longer timing advance (perhaps also with playback device specific timing advances) when generating playback timing for the audio (e.g., the streaming music) that does not have corresponding latency-sensitive video content, and thus, does not have any need for lip synchrony. And when the user switches from listening to music to watching television again, the audio sourcing device switches to using the shorter timing advance again so that playback of the audio is in lip synchrony with the corresponding video.

In some embodiments, the audio sourcing device may switch between different timing schemes (e.g., switching between using shorter timing advances and using longer timing advances with and without player-specific timing advances) during the course of playing the same audio content. Recall from earlier that some audio content (or perhaps some portions of audio content) having corresponding video content may not be latency-sensitive because the video content does not necessarily require lip synchrony.

For example, portions of a movie will generally have latency-sensitive spoken dialog, but other portions of that same movie may not have any spoken dialog at all. For the portions that have spoken dialog, it is desirable to play the audio content containing that spoken dialog in lip synchrony with the portions of the video that show the spoken dialog. But for the portions of the movie that do not have spoken dialog, lip synchrony is not typically relevant. Accordingly, some embodiments include the audio sourcing device switching between using shorter and longer timing advances (with and without playback device specific timing advances) when generating playback timing for the audio content based on whether audio content contains (or does not contain) spoken dialog, or more generally, whether the audio content is latency-sensitive audio content or non-latency-sensitive audio content.

In some embodiments, switching from using shorting timing advances to using longer timing advances in some instances may include changing the timing advance from about 15-20 milliseconds (used for the lip synchrony scheme) to about 65-70 milliseconds (used by the standard and/or sound steering schemes). Rather than abruptly adding ~50 milliseconds to the timing advance, some embodiments include adding a few milliseconds (e.g., 5 milliseconds) every 50-100 milliseconds over a timespan of about 500 milliseconds to 1 second, thus extending the timing offset by about 50 milliseconds over the course of about 500 milliseconds to about 1 second.

Switching from using the longer timing advance to using a shorter timing advance entails performing the process in reverse. Some embodiments may include reducing the timing advance by ~50 milliseconds (and dropping 50 milliseconds of audio). Rather than abruptly reducing the timing advance by ~50 milliseconds, some embodiments include cutting a few milliseconds (e.g., 5 milliseconds) every 50-100 milliseconds over a timespan of about 500 milliseconds to 1 second, thus reducing the timing offset by about 50 milliseconds over the course of about 500 milliseconds to about 1 second by dropping about 50 milliseconds of audio samples over that time frame.

For embodiments that include switching between the lip synchrony scheme and the standard or sound steering schemes for different portions of the audio content (having corresponding video content) that include voice dialog (or lack voice dialog), it can be advantageous to use timing advances for the standard scheme (and perhaps the sound steering scheme) that are no more than about 50-100 milliseconds longer than the timing advances used for the lip synchrony schemes to facilitate faster and less noticeable switching between (i) the lip synchrony scheme (for the portions of the audio content that include voice dialog) and (ii) the standard or sound steering schemes (for the portions of the audio content that lack voice dialog and might benefit from a slightly longer timing advance).

e. Generating Playback Timing With Clock Timing From a Remote Clock

The audio sourcing device uses clock timing from a reference clock to generate playback timing for audio regardless of whether the audio sourcing device uses a shorter timing advance, a longer timing advance, or a playback-device specific timing advance to generate the playback timing. This reference clock may be a clock at the audio sourcing device (as described in the previous section), but the reference clock could be a reference clock at some device that is separate from the audio sourcing device.

Accordingly, in some embodiments, the audio sourcing device may generate playback timing for audio content based on clock timing from a “remote” clock at another network device, e.g., another playback device, another computing device (e.g., a smartphone, tablet computer, smartwatch, or other computing device configurable to provide clock timing sufficient for use by the audio sourcing device to generate playback timing and/or playback audio). Generating playback timing based on clock timing from a remote clock at another network device is slightly more complicated than generating playback timing based on clock timing from a local clock in embodiments where the same clock timing is used for both (i) generating playback timing and (ii) playing audio based on the playback timing.

In embodiments where the audio sourcing device generates playback timing for audio content based on clock timing from a remote clock, the playback timing for an individual frame (or packet) is based on (i) a “timing offset” between (a) a local clock at the audio sourcing device that the audio sourcing device uses for generating the playback timing and (b) the clock timing from the remote reference clock, and (ii) a “timing advance,” which is the duration of time (e.g., between about 10 milliseconds to about 100 milliseconds or more) that the audio sourcing device adds to the current clock time, t, of the reference clock to generate a playback time for a particular frame of audio content, as described above.

For an individual frame (or packet) containing a portion(s) of the audio content, the audio sourcing device generates playback timing for that individual frame (or packet) by adding the sum of the “timing offset” and the “timing advance” to a current time of the local clock at the audio sourcing device that the audio sourcing device uses to generate the playback timing for the audio content. In operation, the “timing offset” may be a positive or a negative offset, depending on whether the local clock at the audio sourcing device is ahead of or behind the remote clock providing the clock timing. The “timing advance” is a positive number because it represents a future time relative to the local clock time, as adjusted by the “timing offset.” By adding the sum of the “timing advance” and the “timing offset” to a current time of the local clock at the audio sourcing device that the audio sourcing device is using to generate the playback timing for the audio content, the audio sourcing device is, in effect, generating the playback timing relative to the remote clock.

In some embodiments, and as described above, the “timing advance” is based on any of the factors disclosed and described in the prior section, including but not necessarily limited to whether (i) the audio content has corresponding video content, (ii) the audio content includes voice dialog that requires playback in lip synchrony with corresponding video showing, (iii) the audio content does not have corresponding video content (e.g., the audio is music from a streaming music service), and/or (iv) the audio content is to be “steered” to a particular listening position within a listening area.

f. Playing Audio Using Local Playback Timing and Local Clock Timing

In some embodiments, the audio sourcing device is configured to play audio in synchrony with one or more group members.

For example, in some home theater bonded zone embodiments, the home theater primary (acting as the audio sourcing device) is configured to play audio in synchrony with the home theater satellites.

When the audio sourcing device is using clock timing from a local clock at the audio sourcing device to generate the playback timing, then the audio sourcing device will play the audio using locally-generated playback timing and the locally-generated clock timing. In operation, the audio sourcing device plays an individual frame (or packet) comprising portions of the audio content when the local clock that the audio sourcing device used to generate the playback timing reaches the time specified in the playback timing for that individual frame (or packet).

For example, recall that when generating playback timing for an individual frame (or packet), the audio sourcing device adds a “timing advance” to the current clock time of the reference clock used for generating the playback timing. In this instance, the reference clock used for generating the playback timing is a local clock at the audio sourcing device. So, if the timing advance for an individual frame is, for example, 40 milliseconds, then the audio sourcing device plays the portion (e.g., a sample or set of samples) of audio content in an individual frame (or packet) 40 milliseconds after creating the playback timing for that individual frame (or packet).

In this manner, the audio sourcing device plays audio based on the audio content by using locally-generated playback timing and clock timing from a local reference clock at the audio sourcing device. By playing the portion(s) of the audio content of an individual frame and/or packet when the clock time of the local reference clock reaches the playback timing for that individual frame or packet, the audio sourcing device is able to play that portion(s) of the audio corresponding to the audio content in that individual frame and/or packet in synchrony with the group member(s).

g. Playing Audio Using Local Playback Timing and Remote Clock Timing

As mentioned earlier, in some embodiments, an audio sourcing device generates playback timing for audio content based on clock timing from a remote clock, i.e., a clock at another network device separate from the audio sourcing device, e.g., another playback device, or another computing device (e.g., a smartphone, laptop, media server, or other computing device configurable to provide clock timing sufficient for use by a playback device to generate playback timing and/or playback audio). Because the audio sourcing device uses clock timing from the “remote” clock to generate the playback timing for the audio content, the audio sourcing device also uses the clock timing from the “remote” clock to play the audio. In this manner, the audio sourcing device plays audio using the locally-generated playback timing and the clock timing from the remote clock.

Recall that in embodiments where the audio sourcing device generates playback timing for audio content based on clock timing from a remote clock, the audio sourcing device generates the playback timing for an individual frame (or packet) based on (i) a “timing offset” that is based on a difference between (a) a local clock at the audio sourcing device and (b) the clock timing from the remote clock, and (ii) a “timing advance.” And further recall that the audio sourcing device transmits the generated playback timing to the group member(s) tasked with playing the audio in the playback group.

In this scenario, to play an individual frame (or packet) of audio content in synchrony with the other group member(s), the audio sourcing device subtracts the “timing offset” from the playback timing for that individual frame (or packet) to generate a “local” playback time for playing the audio based on the audio content within that individual frame (or packet). After generating the “local” playback time for playing the portion(s) of the audio corresponding to the audio content within the individual frame (or packet), the audio sourcing device plays the portion(s) of the audio corresponding to the audio content in the individual frame (or packet) when the local clock that the audio sourcing device is using to play the audio content reaches the “local” playback time for that individual frame (or packet). By subtracting the “timing offset” from the playback timing to generate the “local” playback time for an individual frame, the audio sourcing device effectively plays the portion(s) of audio corresponding to the audio content in that frame/packet with reference to the clock timing from the remote clock.

### H. Playing Audio Using Remote Playback Timing and Local Clock Timing

Recall in some embodiments, the audio sourcing device transmits the audio content and the playback timing for the audio content to the group member(s). For example, in some home theater bonded zone embodiments, the home theater primary transmits audio content and playback timing to the home theater satellites. The home theater satellites in turn use the playback timing to play audio based on the audio content.

When the group member that receives (i.e., the receiving group member) the audio content and playback timing from the audio sourcing device is the same group member that provided clock timing to the audio sourcing device that the audio sourcing device used for generating the playback timing, then the receiving group member in this instance plays audio using the audio content and playback timing received from the audio sourcing device (i.e., remote playback timing) and the group member's own clock timing (i.e., local clock timing). Because the audio sourcing device uses clock timing from a clock at the receiving group member to generate the playback timing, the receiving group member also uses the clock timing from its local clock to play the audio. In this manner, the receiving group member plays audio using the remote playback timing (i.e., from the audio sourcing device) and the clock timing from its local clock (i.e., its local clock timing).

To play an individual frame (or packet) of the audio content in synchrony with the audio sourcing device (and any other playback device that receives the playback timing from the audio sourcing device and clock timing from the receiving group member), the receiving group member (i) receives the frames (or packets) comprising the portions of the audio content from the audio sourcing device, (ii) receives the playback timing for the audio content from the audio sourcing device (e.g., in the frame and/or packet headers of the frames and/or packets comprising the portions of the audio content or perhaps separately from the frames and/or packets comprising the portions of the audio content), and (iii) plays the portion(s) of the audio content in the individual frame (or packet) when the local clock that the receiving group member used to generate the clock timing reaches the playback time specified in the playback timing for that individual frame (or packet) received from the audio sourcing device.

Because the audio sourcing device used the “timing offset” (which is the difference between the clock timing at the receiving group member and the clock timing at the audio sourcing device in this scenario) when generating the playback timing, and because this “timing offset” already accounts for differences between timing at the audio sourcing device and the receiving group member, the receiving group member in this scenario plays individual frames (or packets) comprising portions of the audio content when the receiving group member's local clock (that was used to generated the clock timing) reaches the playback time for an individual frame (or packet) specified in the playback timing for that individual frame (or packet).

And because the receiving group member plays frames (or packets) comprising portions of the audio content according to the playback timing, and because the audio sourcing device plays the same frames (or packets) comprising portions of the audio content according to the playback timing and the determined “timing offset,” the receiving group member and the audio sourcing device are able to play the same frames (or packets) comprising audio content corresponding to the same portions of audio in synchrony, i.e., at the same time or at substantially the same time.

### I. Playing Audio Using Remote Playback Timing and Remote Clock Timing

Recall in some embodiments, the audio sourcing device transmits the audio content and the playback timing for the audio content to the group member playback device(s) in the playback group. For example, in some home theater bonded zone embodiments, the home theater primary transmits the audio content and the playback timing for the audio content to the home theater satellites.

Further recall that in some embodiments, the network device providing the clock timing can be a different device than the playback device providing the audio content and playback timing (i.e., the audio sourcing device, which in some home theater embodiments may be the home theater primary). In some home theater embodiments, the home theater primary provides (i) clock timing, (ii) audio content, and (iii) playback timing for the audio content to the home theater satellites.

A playback device that receives the audio content, the playback timing, and the clock timing from one or more other playback devices is configured to play the audio using the playback timing from the device that provided the playback timing (i.e., remote playback timing) and clock timing from a clock at the device that provided the clock timing (i.e., remote clock timing). In this manner, the receiving group member in this instance plays audio based on audio content by using remote playback timing and remote clock timing. In some home theater embodiments, a home theater satellite plays audio by using remote playback timing and remote clock timing received from the home theater primary.

To play an individual frame (or packet) of the audio content, the receiving playback device (i) receives the frames (or packets) comprising the portions of the audio content, (ii) receives the playback timing for the audio content (e.g., in the frame and/or packet headers of the frames and/or packets comprising the portions of the audio content or perhaps separately from the frames and/or packets comprising the portions of the audio content), (iii) receives the clock timing, and (iv) plays the portion(s) of the audio content in the individual frame (or packet) when the local clock that the receiving playback device uses for audio playback reaches the playback time specified in the playback timing for that individual frame (or packet), as adjusted by a “timing offset.”

In operation, after the receiving playback device receives clock timing, the receiving playback device determines a “timing offset” for the receiving playback device. This “timing offset” comprises (or at least corresponds to) a difference between the “reference” clock that was used to generate the clock timing and a “local” clock at the receiving playback device that the receiving playback device uses to play the audio content. In operation, a playback device that receives the clock timing from another device calculates its own “timing offset” based on the difference between its local clock and the clock timing, and thus, the “timing offset” that each playback device determines for playing audio is specific to that particular playback device.

In some embodiments, when playing audio, the receiving playback device generates new playback timing (specific to the receiving playback device) for individual frames (or packets) of audio content by adding the previously determined “timing offset” to the playback timing for each received frame (or packet) comprising portions of audio content. With this approach, the receiving playback device converts the playback timing for the received audio content into “local” playback timing for the receiving playback device. Because each receiving playback device calculates its own “timing offset” for playback, each receiving playback device's determined “local” playback timing for an individual frame is specific to that particular playback device.

And when the “local” clock that the receiving playback device is using for playing back the audio reaches the “local” playback time for an individual frame (or packet), the receiving playback device plays the audio content (or portions thereof) associated with that individual frame (or packet). As described above, in some embodiments, the playback timing for a particular frame (or packet) is in the header of the frame (or packet). In other embodiments, the playback timing for individual frames (or packets) is transmitted separately from the frames (or packets) comprising the audio content.

Because the receiving playback device plays frames (or packets) comprising portions of the audio content according to the playback timing as adjusted by the “timing offset” relative to the clock timing, and because the device providing the playback timing generated the playback timing for those frames (or packets) relative to the clock timing and (if applicable) plays the same frames (or packets) comprising portions of the audio content according to the playback timing and its determined “timing offset,” the receiving playback device and the audio sourcing device that provided the playback timing (e.g., the home theater primary in some embodiments) are able to play the same frames (or packets) comprising the same portions of the audio content in synchrony with each other, i.e., at the same time or at substantially the same time.

### VI. Example Playback Device and Playback Group Embodiments

The example embodiments described herein include playback devices configured to, among other features, determine whether multichannel audio content received via one or more network interfaces includes corresponding video content.

When the multichannel audio content has been determined to include corresponding video content, some embodiments cause a second playback device to play at least a portion of the multichannel audio content according to a first delay scheme.

In some instances, the first delay scheme comprises the lip synchrony scheme described previously. In operation, the lip synchrony scheme is configured to cause the second playback device to play at least a portion of the multichannel audio content in lip synchrony with playback of video corresponding to the multichannel audio content. In some embodiments, the lip synchrony scheme is implemented at least in part by using a timing advance of no more than about 15 to 20 milliseconds when generating the playback timing for the audio content.

When the multichannel audio content has been determined to not have corresponding video content, some embodiments include causing the second playback device to play at least a portion of the multichannel audio content according to a second delay scheme that is different than the first delay scheme.

In some instances the second delay scheme comprises the standard scheme described previously. In some instances, the second delay scheme comprises the sound steering scheme described previously. The sound steering scheme is configured to cause the at least a portion of the multichannel audio content played by the second playback device and a corresponding portion of the multichannel audio content played by a different playback device to arrive at a listening position at substantially the same time. This sound steering scheme is implemented at least in part by using different timing advances when generating “playback device specific” playback timing for each of the second playback device and the different playback device.

In some embodiments, the first playback device comprises the different playback device.

a. Example System Components

FIG. 7 shows an example configuration of a media playback system 700 comprising four playback devices 702, 704, 706, and 708 configured in a playback group, a video display 730 configured to play video, and a media device 710.

The playback devices 702, 704, 706, and 708, the video display 730, and the media device 710 are communicatively coupled to each other via Local Area Network (LAN) 740. In particular, playback device 702 is connected to LAN 740 via communication link 742, playback device 704 is connected to LAN 740 via communication link 744, playback device 706 is connected to LAN 740 via communication link 746, playback device 708 is connected to LAN 740 via communication link 748, and video display 730 is connected to LAN 740 via communication link 750. Media device 710 is also connected to LAN 740 via a communication link (not shown).

In the illustrated example, the media device 710 and the video display 730 are shown as separate components. In some examples, however, the media device 710 is integrated with the video display 730 or vice versa. Moreover, in certain examples, the playback device 702 comprises aspects of the media device 710 and the video display 730. In some examples, for instance, the playback device 702 comprises a television or projector with integrated audio output (e.g., one or more audio transducers) and one or more input/output interfaces.

Some embodiments additionally include headphones 760. The headphones 760 are configured to communicate with the playback device 702 via communication link 761 to exchange control information and to receive audio content and playback timing. In some embodiments, communication link 761 may be a Bluetooth or similar personal area network link. In other embodiments, the headphones 760 may be connected to the playback device 702 via LAN 740.

The LAN 740 may be any type of wired and/or wireless LAN now known or later developed that is suitable for transmitting and receiving data comprising clock timing, media content (including audio content and video content), and playback timing, as well as control signaling for configuring, controlling, and/or managing media devices such as playback devices, video displays, and/or media hubs in configurations similar to the example configuration shown in FIG. 7.

The playback devices 702, 704, 706, and 708 may be the same as or similar to any of the playback devices (and/or networked microphone devices) disclosed and described herein. In some embodiments, one or more of the playback devices 702, 704, 706, and 708 are portable and are powered via a standard electrical wall outlet and/or via rechargeable batteries.

Similar to other playback devices (and networked microphone devices) described herein, each of the playback devices 702, 704, 706, and 708 includes at least one network interface configured to facilitate communication via WLAN 740. Each of the playback devices 702, 704, 706, and 708 also includes one or more processors and tangible, non-transitory computer-readable media storing program instructions that are executable by the one or more processors to cause the playback device to perform at least some (or perhaps all) of the playback device functions disclosed and described herein.

The playback devices 702, 704, 706, and 708 are configured in a home theater bonded zone arrangement where the playback device 702 is configured as the home theater primary and playback devices 704, 706, and 708 are configured as home theater satellites. In this example configuration, playback device 702 is configured to operate as a left front speaker, playback device 704 is configured to operate as a right front speaker, playback device 706 is configured to operate as a right rear speaker, and playback device 708 is configured to operate as a left rear speaker. In some embodiments, one or both of playback device 702 and playback device 704 may be configured to additionally operate as (or provide audio corresponding to) a center channel.

The home theater bonded zone configuration shown in FIG. 7 is an example of one type of home theater bonded zone configuration suitable for practicing aspects of the disclosed features and functions. Another home theater bonded zone configuration equally suitable for practicing aspects of the disclosed feature and functions includes (i) a soundbar (or similar device) operating as the home theater primary and configured to play front left, front right, and center channel audio, (ii) a subwoofer (or similar) operating as a home theater satellite and configured to play a subwoofer channel, (iii) right rear and left rear playback devices operating as home theater satellites and configured to play one or more rear audio channels, e.g., a right rear and a left rear channel, respectively. Some soundbar implementations may additionally include separate right front and left front playback devices operating as home theater satellites and configured to play one or more front audio channels, e.g., a right front and a right rear channel, respectively. Other home theater bonded zone configurations as well as other groupings of playback devices (e.g., playback groups that may not be home theater bonded zones) could also be suitable for practicing aspects of the content aware multi-channel, multi-device time alignment features and functionality described herein.

In the example home theater bonded zone configuration in FIG. 7, playback device 702 is operating as the home theater primary and configured to perform the audio sourcing functions for the home theater bonded zone.

As the home theater primary and audio sourcing device for the playback group, playback device 702 is configured to perform functions including (i) transmitting clock timing to all of the home theater satellites (i.e., playback devices 704, 706, and 708), (ii) receiving and processing audio content from a media source, (iii) generating playback timing for the audio content, and (iv) transmitting the audio content and the playback timing to the home theater satellites.

b. Transmitting Clock Timing Information

In the example shown in FIG. 7, playback device 702 provides clock timing to all of the home theater satellites, i.e., playback devices 704, 706, and 708. In other embodiments, clock timing information may be provided by a different device configured to function as the reference clock source, as described previously.

In operation, playback devices 702, 704, 706, and 708 exchange clock timing information with each other to facilitate groupwise playback of audio while they are configured in the playback group.

Exchanging the clock timing information between playback device 702 and each of the other home theater satellites includes one or both of (i) playback device 702 providing one or more indications of its clock timing and/or clock rate to one of the home theater satellites (e.g., playback device 704, 706, or 708) and/or (ii) the home theater satellite providing one or more indications of its clock timing and/or clock rate to playback device 702. In some embodiments, the playback device 702 and the home theater satellite exchange clock information on a regular, semi-regular, and/or on-going basis throughout the timeframe during which playback device 702 and the home theater satellite are configured to operate in the home theater bonded zone.

The clock timing information exchanged between playback device 702 and each of the home theater satellites (i.e., playback devices 704, 706, and 708) is the same as or similar to any of the clock timing information disclosed and described herein. For example, and as described previously, playback devices in a grouped playback configuration (e.g., a home theater bonded zone, stereo pair, zone group, or other groupwise playback configurations) exchange clock timing information for several purposes relating to synchronized playback, including but not limited to one or more of determining timing offsets relative to each other, determining a timing advance for generating clock timing, determining differences between clock times, clock rates, and/or clock drifts, and any of the other synchronized playback related functions involving the exchange of clock timing information disclosed and described herein.

c. Receiving Audio Content

Playback device 702 is configured to receive audio content from any suitable media source, including but not limited to media device 710, media service provider 720, video display 730, another playback device, or any other suitable source of media content.

For example, playback device 702 may receive media content (comprising audio content) from a media device 710 (e.g., an Apple TV, Amazon Fire TV Stick, Google TV, a gaming console, DVD player, smartphone, tablet computer, laptop computer, or any other similar device suitable for providing media content) via communication link 749. In some embodiments, communication link 749 is a direct communication link between the media device 710 and the playback device 702. In some embodiments, communication link 749 traverses LAN 740 and/or includes communication link 742.

In some scenarios, media device 710 may obtain media content from a media service provider 720 via communication link 743, and the media device 710 may then, in turn, provide audio and/or video content to the playback device 702 via link 749 and/or the video display 730 via communication link 747. Similar to communication link 749, communication link 747 in some embodiments may be either (i) a direct communication link between the media device 710 and the video display 730 or (ii) a communication link that traverses LAN 740.

Playback device 702 may additionally or alternatively receive media content (comprising audio content) from the video display 730 via communication link 751. In some embodiments, communication link 751 may be a direct communication link between the video display 730 and the playback device 702. In some embodiments, communication link 751 may traverse LAN 740 and/or include communication link 742. In some instances, the video display 730 may receive media content (comprising audio content) from the media device 710 or directly from the media service provider 720, and then, in turn, provide audio content to the playback device 702.

Playback device 702 may additionally or alternatively receive media content (comprising audio content) from the internet-based media service provider 720 via communication link 741 rather than receiving the media content from the internet-based media service provider 720 indirectly via the media device 710 or video display 730. Communication link 741 may in some instances traverse LAN 740 and/or include communication link 742.

d. Processing Received Audio Content and Generating Playback Timing

Playback device 702 processes audio content received from the media source (e.g., any of the media device 710, media service provider 720, video display 730, or other suitable media source) and generates processed audio content (sometimes referred to herein as simply audio content) playback timing for the processed audio content according to any of the audio processing and playback timing generation methods disclosed and described herein.

For example, and as described in detail above, processing the audio content includes the playback device 702 packaging the audio content into a series of frames/packets, where individual frames/packets of audio content include corresponding playback timing that is used by playback devices 702, 704, 706, and 708 to play audio based on the audio content in a groupwise fashion.

In the example home theater bonded configuration shown in FIG. 7, playback device 702 is configured to play a front left channel (and perhaps a center channel) of the multichannel audio based on the audio content and the playback timing in synchrony with (i) playback device 704 playing a front right channel (and perhaps a center channel) of the multichannel audio based on the audio content and the playback timing, (ii) playback device 706 playing a rear right channel of the multichannel audio based on the audio content and the playback timing, and (iii) playback device 708 playing a rear left channel of the multichannel audio based on the audio content and the playback timing.

In some embodiments, playback device 702 determines whether the audio content received via any of its one or more network interfaces has corresponding video content. When playback device 702 has determined that the audio content has corresponding video content, playback device 702 generates playback timing according to the lip synchrony scheme described above. When the playback device 702 has determined that the audio content does not have corresponding video content, playback device 702 generates playback timing according to one of the standard scheme or the sound steering scheme as described above.

As described previously, the sound steering scheme includes generating playback timing for each playback device that causes the playback devices in the playback group to play audio so that corresponding portions of the audio played by different playbacks devices arrive at a listening position at substantially the same time.

Listening position 790 is shown in FIG. 7. Listening position 790 corresponds to a specific location within the listening area to which the playback devices 702, 704, 706, and 708 can steer sound when implementing the sound steering scheme. Listening position 790 is shown in one specific place in FIG. 7, but sound can be steered to any position within an area in which the playback system 700 is operating. The area in which a playback system is operating is sometimes referred to herein as a listening area.

The playback timing for each playback device in the playback system is based on that playback device's distance to the listing position 790.

For example, the timing advance that playback device 702 uses for generating the playback timing that it (i.e., playback device 702) will use for playing the audio content is based on distance between the playback device 702 and position 790.

Similarly, the timing advance that playback device 702 uses for generating the playback timing that playback device 704 will use for playing the audio content is based on distance₂ between the playback device 704 and position 790.

Likewise, the timing advance that playback device 702 uses for generating the playback timing that playback device 706 will use for playing the audio content is based on distance₃ between the playback device 706 and position 790.

Finally, the timing advance that playback device 702 uses for generating the playback timing that playback device 708 will use for playing the audio content is based on distance₄ between the playback device 708 and position 790.

If distance₁, distance₂, distance₃, and distance₄ are all the same, then the timing advance associated with each of the playback devices 702, 704, 706, and 708 may likewise be the same. But if distance₁, distance₂, distance₃, and distance₄ are different distances, then the timing advances corresponding to each of distance₁, distance₂, distance₃, and distance₄ will be different as well.

In the illustrated example of FIG. 7, the distances distance1, distance2, distance3, and distance4 are shown as straight line distances. In some examples, any of the distances described above (e.g., distance1) are acoustic path lengths that are not necessarily single, straight line distances. For instance, in some examples, distance1 corresponds to an acoustic path length of height audio output via one or more audio transducers angled vertically upward with respect to other transducers arranged to output lateral audio (e.g., front or rear output, side surround output). For instance, as described in MacLean '635—incorporated by reference herein above sound output via an up-firing transducer(s) and a side-firing transducer(s) can be time-aligned to arrive at a listener position at substantially the same time based on different corresponding acoustic path lengths associated with reflections from a ceiling (up-firing transducer) and a wall (side-firing transducer), respectively.

In some embodiments, the distances between the playback devices and the listening position 790 can be determined by any of several methods. For example, in some embodiments, each playback device can play a tone or other sound at a specific time and/or play a pattern or series of tones/sounds. These tones/sounds can then be detected, for instance, by a network device (e.g., a smartphone or a playback device; not shown) equipped with a microphone located at the listening position 790. The distance between the playback device that played the tone/sound and/or series of tones/sounds and the network device that detected the tone/sound and/or series of tones/sounds can then be determined based on (i) the time at which the playback device played the tones/sounds and/or series of tones/sounds, (ii) the time at which the smartphone detected the tones/sounds and/or series of tones/sounds, and (iii) the speed of sound.

In some embodiments, the network device may determine the distance between itself and the playback device, and then inform the audio sourcing device (e.g., playback device 702). In some embodiments, the playback device may determine the distance between itself and the smartphone based on data provided by the network device (e.g., the time at which the smartphone received the tones/sounds and/or series of tones/sounds), and then inform the audio sourcing device (e.g., playback device 702).

Regardless of which process is used, the distance determination process can be performed between the network device at the listening position 790 and each playback device.

For example, the distance determination process is performed (i) between the network device and playback device 702 to determine distance₁, (ii) between the smartphone and playback device 704 to determine distance₂, (ii) between the smartphone and playback device 706 to determine distance₃, (ii) between the smartphone and playback device 708 to determine distance_{4.}

In some embodiments, distances for a listening position 790 may be determined at initial system setup. In some embodiments, updated distances (and updated corresponding timing advances) for an updated listening position may be determined after an updated listening position has been designated. In some embodiments, the system may use audio played by the playback devices and detected by the microphone(s) of the smartphone to update the listening position to match a current position of the smartphone within the listening area in real time, substantially real time, periodically, substantially periodically, and/or in response to a command to update the listening position based on the current position of the smartphone.

### VII. Example Methods

FIG. 8 shows an example method 800 implemented by a playback device configured to perform aspects of content-aware multi-channel, multi-device time alignment according to some embodiments.

Aspects of method 800 include groupwise playback of multichannel audio content, including a first playback device (i) playing one or more channels of multichannel audio content according to one of several different delay schemes and/or (ii) causing at least a second playback device to play one or more channels of multichannel audio content according to one of the several different delay schemes. The delay schemes include a lip synchrony scheme, a standard scheme, and a sound steering scheme, each of which has been described in detail herein above.

Some embodiments include all of the playback devices in a playback group playing the multichannel audio content according to the same delay scheme. However, other embodiments may include different playback devices in the same playback group playing the same multichannel audio content according to different delay schemes concurrently. For example, for playback devices configured in a home theater bonded zone configurations, some embodiments include (i) playback devices playing one or more of the left front, left right, and/or center channels of the audio content according to the lip synchrony scheme, and (ii) playback devices playing rear right, rear left, and/or subwoofer channels of the audio content according to either the standard scheme or the sound steering scheme.

Although the blocks are illustrated in sequential order, these blocks may also be performed in parallel, and/or in a different order than the order shown in FIG. 8. Also, the various blocks may be combined into fewer blocks, divided into additional blocks, and/or removed based upon a desired implementation.

One or more (or all) aspects of method 800 can be implemented by any of the playback devices disclosed and described herein, including but not limited to playback device 702, individually or in combination with the other playback devices 704, 706, and 708, all described with reference to FIG. 7.

Also, some aspects of method 800 are described with reference to interactions between a first playback device functioning as an audio sourcing device and a second playback device functioning as a group member of a playback group. Examples of playback groups with a first playback device and a second playback device in this type of configuration include stereo pair groups, bonded zones with two playback devices (including home theater bonded zones with at least two playback devices), synchrony groups with at least two playback devices, or other playback groups with at least two playback devices.

Method 800 is equally applicable to playback groups with three or more playback devices, such as the home theater bonded zone example shown in FIG. 7. For playback groups having three or more playback devices, the first playback device (e.g., playback device 702 configured as a home theater primary and an audio sourcing device) performs the same or substantially the same steps illustrated in method 800 for each of the other playback devices in the playback group. For example, in the home theater bonded zone configuration shown in FIG. 7, if playback device 702 (as the first playback device) is configured as the home theater primary and audio sourcing device, then playback device 702 can perform one or more of the functions illustrated in method 800 with (i) playback device 704 (as the second playback device), (ii) playback device 706 (as a third playback device), and (iii) playback device 708 (as a fourth playback device).

Also, some aspects of method 800 are described from the standpoint of functions performed by a first playback device (e.g., a home theater primary) with reference to a second playback device (e.g., a home theater satellite). However, functions performed by a home theater satellite based on command and control signaling received from a home theater primary are likewise within the scope of method 800.

Method 800 begins at method block 802, which includes a first playback device (e.g., playback device 702) receiving multichannel audio content via a network interface. The network interface may be any type of network interface disclosed herein, including but not limited to one or more wireless interfaces (e.g., WiFi or Bluetooth), one or more wired interfaces (e.g., Ethernet, HDMI, FireWire, USB-A/B/C, Thunderbolt), or any other type of network interface now known or later developed that is suitable for transmitting and receiving media content.

In some embodiments, method 800 advances to optional block 804, which includes the first playback device determining whether the multichannel audio content is to be played back via either (i) headphones or (ii) a group of playback devices, e.g., a home theater bonded zone. In certain examples, multichannel audio content can be played via both (i) one or more headphones and (ii) a group of playback devices. For instance, in some examples, the media playback system can determine that the wearer(s) of the one or more headphones are in one or more second locations away from a first location (e.g., the position 790 in FIG. 7) in which the playback device 702 is located. For example, the headphone wearer(s) may be in a different room, on the patio or otherwise outside a house/dwelling, inside a different building altogether, in a vehicle etc. with respect to the position 790. Based on the determined second location(s), the method 800 may comprise determining that multichannel audio content should be played back via both the group of playback devices and the one or more headphones according to the same delay scheme or different delay schemes as described above. In some of these scenarios, the method 800 may progress from block 802 to block 808. In certain scenarios, for instance, block 806 may follow block 808.

Moreover, method block 804 is shown in method 800 as occurring between steps 802 and 806. However, in some embodiments, method block 804 may be implemented as an interrupt function or similar type of function that could be performed at any time during execution of method 800. In such embodiments, at any time during the execution of method 800 after the playback device determines that playback of the multichannel audio content is to be switched to being played back via headphones (e.g., at block 804), the playback device (i) causes the second playback device (and the other playback device(s) in the playback group, if applicable) to cease playing the multichannel audio content (if they are currently playing the multichannel audio content) and (ii) causes the headphones to play back the multichannel audio content at block 806.

In some embodiments, the block 806 step of causing the one or more headphones to play back the multichannel audio includes causing the one or more headphones to play back the multichannel audio content according to the standard scheme, which is described in detail above.

In other embodiments, the block 806 step of causing the one or more headphones to play back the multichannel audio includes causing the one or more headphones to play back the multichannel audio content according to the lip synchrony scheme, which is described in detail above. In some instances, causing the headphones to play back the multichannel audio content according to the lip synchrony scheme at block 806 includes causing the headphones to play back the multichannel audio content according to the lip synchrony scheme even if the audio content does not have corresponding video content.

Recall from earlier that the lip synchrony scheme includes using a timing advance of less than about 15-20 milliseconds when generating playback timing for the audio content. Using a short timing advance of 15-20 milliseconds results in a very short delay between the time that the audio content is received by the first playback device and subsequently played by the headphones. However, the shorter amount of time for the first playback device to process the audio content, generate the playback timing, and transmit the audio content (and playback timing) to the headphones (and the for the headphones to receive, process, and playback the audio content based on the audio timing) is less likely to cause momentary dropouts as compared to scenarios where the first playback device needs to distribute audio content and playback timing to several different playback devices.

However, in other embodiments (not shown), the playback device may cause the headphones to play the multichannel audio content according to the lip synchrony scheme or the standard scheme based on whether the audio content has corresponding video or not. For example, in some embodiments, the playback device causes the headphones to play the multichannel audio content according to (i) the lip synchrony scheme when the multichannel audio content has corresponding video content and (ii) the standard scheme when the multichannel audio content does not have corresponding video content.

After (or perhaps while) causing the headphones to play the audio content at block 806, some embodiments include returning to block 804 to determine whether playback of the audio content is to be switched from played back via the headphones to instead being played back via the one or more playback devices.

If at block 804, the first playback device determines that the multichannel audio content is to be played back via one or more playback devices, then method 800 advances to block 808 which includes determining whether the multichannel audio content has corresponding video content.

In some embodiments where block 804 is implemented as an interrupt, method 800 may advance from block 802 directly to block 808.

In some embodiments, the block 808 step of determining whether the multichannel audio content has corresponding video content includes the first playback device determining whether the multichannel audio content has corresponding video content based on metadata associated with the multichannel audio content. For example, in some scenarios, the audio content may include metadata that identifies the audio content as (i) a soundtrack accompanying a television program or movie, (ii) audio content for a video game, or (iii) some other audio content having corresponding video content.

In some embodiments, the metadata associated with the multichannel audio content is received from one of (i) a source of the multichannel audio content or (ii) a media lookup service. For example, in some instances, the first playback device (or perhaps another device in the playback system) may use metadata associated with the audio content to lookup information about the audio content from a media lookup service to determine whether the audio content has associated video content.

In some embodiments, the metadata associated with the multichannel audio content includes a source of the multichannel audio content. The source of the multichannel audio content can be used individually or in combination with other metadata and/or machine learning classification procedures to determine whether the multichannel audio content (i) has corresponding video content that includes voice dialog, (ii) has corresponding video content that does not include voice dialog, or (iii) does not have corresponding video content.

For example, in some instances, audio content that is received from a local media device (e.g., media device 710 in FIG. 7) may be presumed to have corresponding video content (and perhaps video content with voice dialog) unless (and/or until) it has been determined that the audio content received from the local media device does not have corresponding video content.

Similarly, audio content that is received from a video device (e.g., video display 730 in FIG. 7) may likewise be presumed to have corresponding video content (and perhaps video content with voice dialog) unless (and/or until) it has been determined that the audio content received via the video device does not have corresponding video content.

By contrast, audio content received from a music streaming service may be presumed to not have corresponding video content unless (and/or until) it has been determined that the audio content received from the music streaming service has corresponding video content. In some examples, even if there is corresponding video content received from a music streaming service, it may be either (i) more sensitive to latency (e.g., video with human singers or other speakers, characters, graphics, or actions depicted in the corresponding video for which using a low latency delay scheme would be advantageous) in which a lip synchrony delay scheme may be used, or (ii) less sensitive to latency (e.g., lyrics, a slide show, an algorithmically-generated graphical output based on the audio) in which a standard delay scheme may be used.

Nevertheless, because media content comprising both video and audio is increasingly available from a variety of media sources, some embodiments include performing the functions of block 808 for all media content regardless of the source. But some embodiments may begin with the above-described presumptions based on the media source as an initial determination while confirming whether the audio includes video content (and perhaps video content with voice dialog) via any one or more of the other mechanisms disclosed herein.

In some embodiments, the block 808 step of determining whether the multichannel audio content has corresponding video content includes the first playback device additionally or alternatively determining whether the multichannel audio content has corresponding video content based on a software-implemented analysis of the multichannel audio content. In some scenarios, block 808 includes using a machine learning classifier to determine whether the multichannel audio content has corresponding video content. In some embodiments, the machine learning classifier has been trained to classify multichannel audio content as one of at least (i) multichannel audio content that has corresponding video content or (ii) multichannel audio content that does not have corresponding video content.

In some embodiments, the block 808 step of determining whether the multichannel audio content has corresponding video content includes determining whether the multichannel audio content has both (i) corresponding video content and (ii) voice dialog. In some embodiments that include determining whether the multichannel audio content includes both corresponding video content and voice dialogue, block 808 includes using a machine learning classifier to determine whether the multichannel audio content has both (i) corresponding video content and (ii) voice dialog. In such embodiments, the machine learning classifier may include a machine learning classifier that has been trained to classify multichannel audio content as one of at least (i) multichannel audio content that has corresponding video content that includes voice dialog, (ii) multichannel audio content that has corresponding video content that does not include voice dialog, or (iii) multichannel audio content that does not have corresponding video content.

In some embodiments, the first playback device performs the block 808 step of determining whether multichannel audio content has corresponding video content whenever the first playback device receives new multichannel audio content.

For example, if the first playback device determines that the multichannel audio content includes corresponding video content, such as audio content for a television program or movie, the first playback device advances to block 810, and causes a second playback device to play at least a portion of the multichannel audio content according to the lip synchrony scheme for the entire duration of the television program or movie. And then, when the first playback device receives new multichannel audio content (e.g., after the end of the television program or movie, when changing to playing multichannel audio content from a different source, or some other change or event that results in the playback device receiving new/different multichannel audio content), the first playback device returns to the block 808 step of determining whether the multichannel audio content has corresponding video content (and perhaps video content with voice dialog).

In some embodiments, method 800 includes performing method step 808 in an ongoing manner during playback of multichannel audio content. For example, many television programs and movies have portions that include voice dialog and portions that do not include voice dialog.

For multichannel audio content that has corresponding video content, it can be advantageous to (i) play portions of the multichannel audio content that include voice dialog according to the lip synchrony delay scheme and (ii) play other portions of the multichannel audio that do not include voice dialog according to either the standard scheme or the sound steering scheme. By playing the portions having voice dialog according to the lip synchrony delay scheme but playing other portions that do have voice dialog according to a more “relaxed” delay scheme (i.e., a delay scheme with timing advances greater than the 20-22 millisecond upper limit for the lip synchrony scheme), some embodiments can play audio having voice dialog in synchrony with the display of the corresponding video depicting the voice dialog while reducing the likelihood of temporary audio dropouts during playback of audio that does not include voice dialog according to the standard and/or sound steering schemes.

Accordingly, in some embodiments, the block 808 step of determining whether multichannel audio content has corresponding video content includes the first playback determining whether different portions of the multichannel audio content have corresponding video content that includes voice dialog.

Then, for a first portion of the multichannel audio content that includes voice dialog, the first playback device causes the second playback device to play the first portion of the multichannel audio content according to the lip synchrony scheme. And for a second portion of the multichannel audio content that has been determined to not include voice dialog, the first playback device causes the second playback device to play the second portion of the multichannel audio content according to one of the standard scheme or the sound steering scheme.

In some embodiments where the first playback device also plays the multichannel audio content with the second playback device, (i) causing the second playback device to play the first portion of the multichannel audio content according to the lip synchrony scheme includes the causing the second playback device to play the first portion of the multichannel audio content according to the lip synchrony scheme in synchrony with the first playback device playing back the first portion of the multichannel audio content according to the lip synchrony scheme, and (ii) causing the second playback device to play the second portion of the multichannel audio content according to one of the standard scheme or the sound steering scheme includes causing the second playback device to play the first portion of the multichannel audio content according to the standard scheme or the sound steering scheme in synchrony with the first playback device playing back the first portion of the multichannel audio content according to the standard scheme or the sound steering scheme.

In some embodiments, determining whether a particular portion of multichannel audio that has corresponding video content also contains voice dialog includes determining whether the particular portion of multichannel audio content has corresponding video content that includes voice dialog via a software-implemented analysis of the multichannel audio content performed by a machine learning classifier trained to classify multichannel audio content as one of at least (i) multichannel audio content that has corresponding video content that includes voice dialog, (ii) multichannel audio content that has corresponding video content that does not include voice dialog, or (iii) multichannel audio content that does not have corresponding video content.

In some embodiments, for audio content with corresponding video that includes voice dialog, the first playback device and the second playback device are configured to play portions of audio content with voice dialog according to the lip synchrony scheme and play portions of the audio content without voice dialog according to one of the standard scheme or the sound steering scheme.

However, in other embodiments, the first playback device and the second playback device are configured to play audio content that has corresponding video content according to the lip synchrony scheme regardless of whether the audio content includes voice dialog or not.

If at block 808, the first playback device determines that the multichannel audio content includes corresponding video content (and/or perhaps video content with voice dialog), method 800 advances to block 810, which includes the first playback device causing the second playback device to play at least a portion of the multichannel audio content according to the first delay scheme.

In some embodiments, the first delay scheme is configured to cause the second playback device to play at least a portion of the multichannel audio content in lip synchrony with playback (e.g., via a video display) of video corresponding to the multichannel audio content. In some embodiments, causing the second playback device to play at least a portion of the multichannel audio content in lip synchrony with playback of video corresponding to the multichannel audio content includes the first playback device generating playback timing according to the lip synchrony scheme described earlier. In some embodiments, both the first playback device and the second playback device play the audio content in synchrony with each other according to the lip synchrony scheme.

In some embodiments, the first delay scheme is configured to cause the second playback device to play at least a portion of the multichannel audio content in lip synchrony with playback of video (e.g., via a video display) corresponding to the multichannel audio content even if causing the second playback device to play the at least a portion of the multichannel audio content in lip synchrony with playback of the video corresponding to the multichannel audio content causes a difference in playback times between (i) the at least a portion of the multichannel audio content played by the second playback device and (ii) a corresponding portion of the multichannel audio content played by a different playback device.

For example, in some embodiments, when video content is being played back via a home theater bonded zone, the home theater primary (e.g., the first playback device) may itself play the audio content in lip synchrony with the corresponding video content, and also cause one or more front home theater satellites (e.g., the second playback device(s)) to play the audio content in lip synchrony with the video content even if the rear home theater satellites may not be able to play the audio content in lip synchrony with the video content, or at least not able to play the audio content as tightly in lip synchrony with the video content as the home theater primary and/or front home theater satellite(s).

If at block 808, the first playback device determines that the multichannel audio content does not include corresponding video content, method 800 advances to block 812, which includes the first playback device causing the second playback device to play at least a portion of the multichannel audio content according to a second delay scheme that is different than the first delay scheme.

In some embodiments, the second delay scheme comprises the sound steering scheme described above. In such embodiments, the sound steering scheme is configured to cause the at least a portion of the multichannel audio content played by the second playback device and a corresponding portion of the multichannel audio content played by a different playback device to arrive at a listening position at substantially the same time. In some embodiments, causing the second playback device to play at least a portion of the multichannel audio content according to the sound steering scheme includes the first playback device generating playback timing according to the sound steering scheme described earlier.

In some embodiments, the second delay scheme comprises the standard delay scheme described above. In such embodiments, causing the second playback device to play at least a portion of the multichannel audio content according to the second delay scheme includes the first playback device generating playback timing according to the standard scheme described earlier.

Some embodiments of method 800 where the second delay scheme includes the sound steering scheme described above additionally include updating the second delay scheme when the listening position in the listening area changes. For example, if the listening position is based on a current location of a smartphone, some embodiments of method 800 include updating the timing advances used for generating the playback timing for individual playback devices after (or perhaps in response to) determining what the location of the smartphone within the listening area has changed.

Accordingly, in some embodiments, method 800 additionally includes optional method block 814, which includes the first playback device determining whether the listening position has changed.

If at block 814, the listening position has not changed, then method 800 returns to block 812, which includes the first playback device continuing to cause the second playback device to play at least a portion of the multichannel audio content according to a second delay scheme, without any modification to the second delay scheme. In some embodiments, continuing to cause the second playback device to play at least a portion of the multichannel audio content according to the second delay scheme, without any modification to the second delay scheme, includes the first playback device continuing to generate playback timing for the second playback device based on the original listening position (e.g., based on the original distance between the second playback device and the original listening position).

But if at block 814, the listening position has changed to a new listening position, then method 800 advances to block 816, which includes updating the second delay scheme based on the new listening position.

In some embodiments, updating the second delay scheme based on the new listening position includes (i) determining a new distance between the second playback device and the new listening position, and (ii) the first playback device updating the timing advance used for generating the playback timing that the second playback device will use for playing the multichannel audio content, where the updated timing advance is based on the updated distance between the second playback device and the new listening position. In some embodiments, the new distance between the second playback device and the new listening position can be determined in same way that the original distance between the second playback device and the original listening position was determined, which is described in further detail with reference to FIG. 7.

For ease of illustration, some of the method blocks in method 800 are described as being performed by the first playback device. For example, method blocks 804, 808, 814, and 816 are described as being performed by the first playback device. However, any of method blocks 804, 808, 814, and or 816 (as well as any of the other blocks of method 800) can be performed by any one or more of the following, individually or in combination with each other: (i) the first playback device, (ii) the second playback device, (iii) another playback device (e.g., a third, fourth, etc. playback device), (iv) a computing device configured to control the playback system, e.g., a smartphone, tablet, laptop or other computing device running a software application for controlling the playback system and/or individual playback devices (v) a computing device and/or computing system configured to monitor and/or control the playback system and/or individual playback devices, such as a cloud computing system.

### VIII. Conclusions

The above discussions relating to playback devices, controller devices, playback zone configurations, and media/audio content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1-20. (canceled)

21. Tangible, non-transitory computer-readable media comprising program instructions executable by one or more processors such that a first playback device is configured to perform functions comprising:
determining, based on a predetermined threshold time associated with maintaining lip synchrony with corresponding video content, a first delay scheme associated with a first type of media content;
determining a listening position relative to corresponding positions of a plurality of playback devices, wherein the positions of the plurality of playback devices include a first position of the first playback device and a second position of a second playback device;
determining, based on the determined listening position, a second delay scheme associated with a second type of media content, wherein the second delay scheme comprises (i) a first timing advance associated with a first sound wave propagation time between the first position and the listening position, and (ii) a second timing advance associated with a second sound wave propagation time between the second position and the listening position;
receiving, via a first input interface of the first playback device, first audio content;
causing, via a network interface, playback of at least a portion of the first audio content via the second playback device according to the first delay scheme;
receiving, via a second input interface of the first playback device, second audio content;
determining that the received second audio content comprises the second type of media content; and
causing, after the received second audio content has been determined to comprise the second type of media content, the second playback device to play at least a second portion of the second audio content according to the second timing advance while the first playback device plays back a first portion of the second audio content according to the first timing advance.

22. The tangible, non-transitory computer-readable media of claim 21, wherein the first type of media content comprises audio content associated with dialog, and wherein the second type of media content comprises audio content associated with a lack of dialog.

23. The tangible, non-transitory computer-readable media of claim 21, wherein the second type of media content is associated with video content and lacks dialog.

24. The tangible, non-transitory computer-readable media of claim 21, wherein determining the listening position comprises:
determining a first distance between the first position and the listening position; and
determining a second distance between the second position and the listening position.

25. The tangible, non-transitory computer-readable media of claim 24, wherein determining the second distance comprises:
causing, via the network interface, the second playback to device to output a pattern of sounds;
determining, based on microphone data corresponding to the pattern of sounds, a time of flight between the second position and the listening position.

26. The tangible, non-transitory computer-readable media of claim 21, wherein the first input interface is the same as the second input interface.

27. The tangible, non-transitory computer-readable media of claim 26, wherein the first input interface and the second input interface comprise the network interface.

28. The tangible, non-transitory computer-readable media of claim 21, wherein the first input interface differs from the second input interface.

29. The tangible, non-transitory computer-readable media of claim 28, wherein the first input interface comprises a hardware interface and wherein the second input interface comprises the network interface.

30. The tangible, non-transitory computer-readable media of claim 28, wherein the first input interface comprises a first hardware interface and wherein the second input interface comprises a second, different hardware interface.

31. The tangible, non-transitory computer-readable media of claim 21, wherein determining that the received second audio content comprises the second type of media content comprises using one or more machine learning techniques to identify audio content associated with video content lacking dialog.

32. The tangible, non-transitory computer-readable media of claim 21, wherein the first audio content comprises dialog and wherein the second audio content comprises music.

33. The tangible, non-transitory computer-readable media of claim 21, wherein the first audio content corresponds to a first portion of video content and the second audio content corresponds to a second portion of the same video content.

34. The tangible, non-transitory computer-readable media of claim 21, wherein the first playback device comprises a display.

35. A method comprising:
determining, based on a predetermined threshold time associated with maintaining lip synchrony with corresponding video content, a first delay scheme associated with a first type of media content;
determining a listening position relative to corresponding positions of a plurality of playback devices, wherein the positions of the plurality of playback devices include a first position of the first playback device and a second position of a second playback device;
determining, based on the determined listening position, a second delay scheme associated with a second type of media content, wherein the second delay scheme comprises (i) a first timing advance associated with a first sound wave propagation time between the first position and the listening position, and (ii) a second timing advance associated with a second sound wave propagation time between the second position and the listening position;
receiving, via a first input interface of the first playback device, first audio content;
causing, via a network interface, playback of at least a portion of the first audio content via the second playback device according to the first delay scheme;
receiving, via a second input interface of the first playback device, second audio content;
determining that the received second audio content comprises the second type of media content; and
causing, after the received second audio content has been determined to comprise the second type of media content, the second playback device to play at least a second portion of the second audio content according to the second timing advance while the first playback device plays back a first portion of the second audio content according to the first timing advance.

36. The method of claim 35, wherein the first input interface is the same as the second input interface, and wherein the first input interface and the second input interface comprise the network interface.

37. The method of claim 35, wherein the first type of media content comprises audio content associated with dialog, and wherein the second type of media content comprises audio content associated with a lack of dialog.

38. A system comprising:
one or more processors; and
tangible, non-transitory computer-readable media storing program instructions, wherein the program instructions, when executed by the one or more processors, cause the system to:
determine, based on a predetermined threshold time associated with maintaining lip synchrony with corresponding video content, a first delay scheme associated with a first type of media content;
determine a listening position relative to corresponding positions of a plurality of playback devices, wherein the positions of the plurality of playback devices include a first position of the first playback device and a second position of a second playback device;
determine, based on the determined listening position, a second delay scheme associated with a second type of media content, wherein the second delay scheme comprises (i) a first timing advance associated with a first sound wave propagation time between the first position and the listening position, and (ii) a second timing advance associated with a second sound wave propagation time between the second position and the listening position;
receive, via a first input interface of the first playback device, first audio content;
cause, via a network interface, playback of at least a portion of the first audio content via the second playback device according to the first delay scheme;
receive, via a second input interface of the first playback device, second audio content;
determine that the received second audio content comprises the second type of media content; and
cause, after the received second audio content has been determined to comprise the second type of media content, the second playback device to play at least a second portion of the second audio content according to the second timing advance while the first playback device plays back a first portion of the second audio content according to the first timing advance.

39. The system of claim 38, wherein the first input interface is the same as the second input interface, and wherein the first input interface and the second input interface comprise the network interface.

40. The system of claim 38, wherein the first type of media content comprises audio content associated with dialog, and wherein the second type of media content comprises audio content associated with a lack of dialog.
